(19) United States
(12) Patent Application Publication
(10) Pub. No.: US 2013/0218592 A1
(43) Pub. Date: Aug. 22, 2013

(54) SYSTEMS AND METHODS FOR FACILITATING CONSOLIDATED MANAGEMENT AND DISTRIBUTION OF VETERINARY CARE DATA

(71) Applicant: Ali Jamal Hashmat, Westbury, NY (US)

(72) Inventor: Ali Jamal Hashmat, Westbury, NY (US)

(73) Assignee: CurePet, Inc., Bellport, NY (US)

(21) Appl. No.: 13/398,100

(22) Filed: Feb. 16, 2012

(51) Int. Cl. G06Q 50/24

(52) U.S. Cl. 705/3

(57) ABSTRACT

According to various embodiments, veterinary care management systems and associated methods are provided for managing electronic medical records and administrative data related to a veterinary care practice. The systems and methods may be used, for example, by a veterinary clinic, related specialty hospital/university facilities, and/or customers and patients thereof to seamlessly and electronically exchange any of a variety of data related to the provision of veterinary care. In certain embodiments, the systems and methods are configured for receiving data associated with at least one patient. In those and other embodiments, at least a portion of the received data is used to facilitate providing medical services for the at least one patient. Various embodiments update at least a portion of the data based upon facilitated medical services, while certain embodiments transmit the updated data, via a network, to users located at distributed sites to facilitate still further medical services or treatment.

### BACKGROUND

1. Field of Various Embodiments of the Invention

Various embodiments of the invention pertain to the field of veterinary care management and more particularly to a comprehensive electronic medical record and veterinary office management system.

2. Related Art

Medical record-keeping, including at least the storage, retrieval, analysis, and transmittal of patient records, as well as office management, including at least scheduling, billing, and treatment transactions, are both vital aspects of providing quality and efficient veterinary care. Traditionally, however, many of these functions have been performed by separate systems and/or entities, thus not being seamlessly integrated together.

In regard to general office management, owners and pets (e.g., patients) check in upon arrival and office personnel may manually record updated information in a physical file associated with the owner and/or patient. Upon completion of such tasks, the office personnel may place the owner and patient in a room and record patient vitals or any concerns voiced by the owner. Office personnel then typically leave the room, placing the patient's physical file (or, alternatively, some other sort of indicator) outside the door to the room. A doctor (e.g., a veterinarian) periodically monitors the rooms to see whether a patient is waiting, at which time the veterinarian enters the room to see the owner and patient. If assistance is required, the veterinarian walks to the assistant or reception area and verbally requests such. Once an appointment is completed, payment and scheduling of subsequent appointments occur back at the front desk, all generally manually entered by office personnel. As such, office management may be unduly prone to inefficiencies and inaccuracies given the duplicative transcription involved with the multiple steps and resources required to complete critical activities.

In regard to medical record management, typically once a physical file is pulled and notated by the office personnel, the veterinarian will further take notes by hand or via dictation regarding treatment, analysis, and diagnosis of the patient. Related advice to owners, whether regarding medical treatment, general care, or otherwise, is generally given verbally. Any text generated during the appointment is thus totally independent of any medications prescribed, labs ordered, handouts given, payment received, insurance notifications, and/or referrals made to specialty hospitals (e.g., for more in depth treatment, diagnosis, or surgery, however the case may be). That is to say, the veterinarian and/or office personnel have to do one function to initiate an action (e.g., printing out a prescription), and then take another action (e.g., document a physical file or patient chart that a prescription was given), and then possibly take still further action (e.g., determining possible insurance co-pay amounts for such a prescription, if inquired upon by the owner of the patient). As such, medical record management may be may be unduly prone to inefficiencies and inaccuracies given the duplicative transcription involved with the multiple steps and resources required to complete critical activities.

Thus, there is a need in the art for a comprehensive electronic veterinary office management system that provides for electronic storage, retrieval, analysis, and transmittal of patient (and owner) records, and which is further tightly integrated with office scheduling, testing, treatment, prescribing, billing, referring, and notifying. The system could also provide seamless electronic communication between the various parties involved in such practices, including but not limited to veterinarians, specialty hospitals, pharmacies, insurance companies, medical laboratories, and the patients and owners themselves. In this manner, such a system would have the advantages of, among other things, complete integration, thereby reducing the number of tasks required by office personnel so as to increase both efficiency and accuracy and also facilitating the sharing of information on a real-time basis, thereby reducing the inconvenience and delay often encountered within traditional systems.

### BRIEF SUMMARY OF THE INVENTION

According to various embodiments of the present invention, a veterinary care management system is provided for facilitating the medical treatment and administrative activities of a veterinary clinic. Various embodiments of the care management system include one or more memory storage areas; and one or more computer processors that are configured to receive data stored in the one or more memory storage areas, wherein the one or more computer processors are configured for: receiving data associated with at least one patient of a user of the system; using at least a portion of the data to facilitate providing medical services for the at least one patient at a first location; updating at least a portion of the data based at least in part upon the facilitated medical services at the first location; and transmitting at least the updated portion of the data via a network to facilitate providing further medical services for the at least one patient at a second location.

According to other embodiments of the present invention, a computer-implemented method for managing a veterinarian care practice is provided. The method comprises the steps of: (A) receiving data stored in a memory, said data comprising data associated with at least one patient; (B) determining, via at least one computer processor, the usefulness of at least a portion of the data for facilitating providing initial medical services for the at least one patient; (C) updating, via the at least one computer processor, at least a portion of the useful portion of data based at least in part upon the facilitated medical services; and (D) transmitting, via the at least one computer processor and an associated network, at least the updated portion of the data, the updated portion being used to facilitate providing further medical services for the at least one patient at a second location.

According to other embodiments of the present invention, a computer program product is provided for managing a veterinarian care practice. Various embodiments of the computer program product include at least one computer-readable storage medium having computer-readable program code portions embodied therein, the computer-readable program code portions comprising: a first executable portion configured for receiving data associated with at least one patient of a user of the system, said data comprising financial data and medical record data; a second executable portion configured for using at least a portion of the data to facilitate providing medical services for the at least one patient at a first location; a third executable portion configured for updating at least a portion of the data based at least in part upon the facilitated medical services at the first location; and a fourth executable portion configured for transmitting at least the updated portion of the data via a network to facilitate providing further medical services for the at least one patient at a second location.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a block diagram of a veterinary care management system 5 according to various embodiments;

FIG. 2 is a schematic block diagram of a management server 200 according to various embodiments of the veterinary care management system shown in FIG. 1;

FIG. 3 is a schematic block diagram of how each of an admin module 500, a financial module 600, an EMR module 700, a prescription module 1000, a radiology module 1100, a laboratory module 1200, a referral module 1300, a customer portal module 1500, and a plurality of plug-in modules 2000 communicate and interact with a data module 400, all according to various embodiments of the information management server shown in FIG. 2;

FIG. 4 is a flow diagram of steps executed by the information management server 200 shown in FIG. 2 according to various embodiments;

FIG. 5 is a flow diagram of steps executed by the admin module 500 shown in FIG. 2 according to various embodiments;

FIG. 6 is a flow diagram of steps executed by the financial module 600 shown in FIG. 2 according to various embodiments;

FIG. 7 is a flow diagram of steps executed by the EMR module 700 shown in FIG. 2 according to various embodiments;

FIG. 8 is a flow diagram of steps executed by the prescription module 1000 shown in FIG. 2 according to various embodiments;

FIG. 9 is a flow diagram of steps executed by the radiology module 1100 shown in FIG. 2 according to various embodiments;

FIG. 10 is a flow diagram of steps executed by the laboratory module 1200 shown in FIG. 2 according to various embodiments;

FIG. 11 is a flow diagram of steps executed by the referral module 1300 shown in FIG. 2 according to various embodiments;

FIG. 12 is a flow diagram of steps executed by the customer portal module 1500 shown in FIG. 2 according to various embodiments;

FIG. 13 is a flow diagram of steps executed by an App Mart module 2100, one of the plurality of plug-in modules 2000 shown in FIG. 2 according to various embodiments;

FIG. 14 is a flow diagram of steps executed by an insurance module 2200, one of the plurality of plug-in modules 2000 shown in FIG. 2 according to various embodiments;

FIG. 15 is a flow diagram of steps executed by an analytics module 2300, one of the plurality of plug-in modules 2000 shown in FIG. 2 according to various embodiments;

FIG. 16 is a flow diagram of steps executed by a community module 2400, one of the plurality of plug-in modules 2000 shown in FIG. 2 according to various embodiments;

FIG. 17 is a flow diagram of steps executed by a reference module 2500, one of the plurality of plug-in modules 2000 shown in FIG. 2 according to various embodiments;

FIG. 18 is an illustration of an exemplary dashboard screen display 3000 of the veterinary care management system 5 according to various embodiments;

FIG. 19 is an illustration of an exemplary scheduling screen display 3100 of the veterinary care management system 5 according to various embodiments;

FIG. 20 is an illustration of an exemplary EMR screen display 3200 of the veterinary care management system 5 according to various embodiments;

FIG. 21 is an illustration of an exemplary financial screen display 3300 of the veterinary care management system 5 according to various embodiments; and

FIG. 22 is an illustration of an exemplary payment screen display 3400 of the veterinary care management system 5 according to various embodiments.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### I. APPARATUSES, METHODS, SYSTEMS, AND COMPUTER PROGRAM PRODUCTS

As should be appreciated, various embodiments may be implemented in various ways, including as apparatuses, methods, systems, or computer program products. Accordingly, the embodiments may take the form of an entirely hardware embodiment or an embodiment in which one or more processors are programmed to perform certain steps. Furthermore, various implementations may take the form of a computer program product on a computer-readable storage medium having computer-readable program instructions embodied in the storage medium. Any suitable computer-readable storage medium may be utilized including hard disks, CD-ROMs, optical storage devices, or magnetic storage devices.

Various embodiments are described below with reference to block diagrams and flowchart illustrations of methods, apparatuses, systems, and computer program products. It should be understood that each block of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, could be implemented by special purpose hardware-based computer systems that perform the specified functions or operations, or combinations of special purpose hardware and computer instructions.

### II. EXEMPLARY SYSTEM ARCHITECTURE

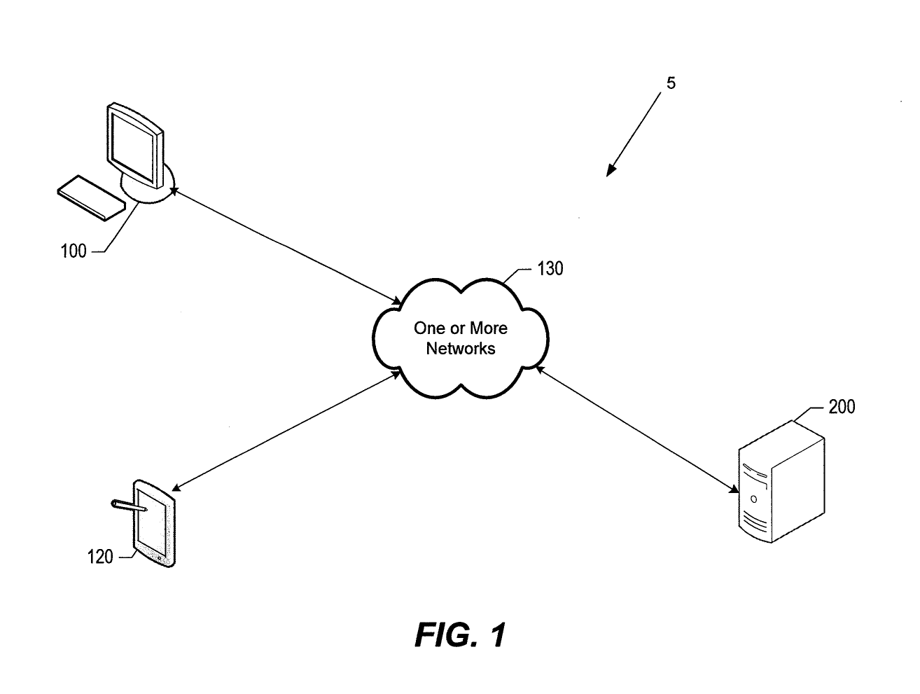

FIG. 1 provides an illustration of an exemplary veterinarian care management system 5 that can be used in conjunction with various embodiments of the present invention. As shown, in FIG. 1, the system may include one or more networks 130, one or more data acquisition devices 120, an information management server 200, and a remote terminal 100. While FIG. 1 illustrates the various system entities as separate, standalone entities, the various embodiments are not limited to this particular architecture.

According to various embodiments of the present invention, the one or more networks 130 may be capable of supporting communication in accordance with any one or more of a number of second-generation (2G), 2.5G, third-generation (3G), and/or fourth-generation (4G) mobile communication protocols, or the like. More particularly, the one or more networks 130 may be capable of supporting communication in accordance with 2G wireless communication protocols IS-136 (TDMA), GSM, and IS-95 (CDMA). Also, for example, the one or more networks 130 may be capable of supporting communication in accordance with 2.5G wireless communication protocols GPRS, Enhanced Data GSM Environment (EDGE), or the like. In addition, for example, the one or more networks 130 may be capable of supporting communication in accordance with 3G and 4G wireless communication protocols such as Universal Mobile Telephone System (UMTS) network employing Wideband Code Division Multiple Access (WCDMA) radio access technology. Some narrow-band AMPS (VAMPS), as well as TACS, network(s) may also benefit from embodiments of the present invention, as should dual or higher mode mobile stations (e.g., digital/analog or TDMA/CDMA/analog phones). As yet another example, each of the components of the system 5 may be configured to communicate with one another in accordance with techniques such as, for example, radio frequency (RF), Bluetooth™, infrared (IrDA), or any of a number of different wired and/or wireless networking techniques, including a wired or wireless Personal Area Network (“PAN”), Local Area Network (“LAN”), Metropolitan Area Network (“MAN”), Wide Area Network (“WAN”), or the like.

Although the one or more data acquisition devices 120, the information management server 200, and the one or more remote terminals 100 are illustrated in FIG. 1 as communicating with one another over the same one or more networks 130, these devices may likewise communicate over multiple, separate networks. For example, while the one or more data acquisition devices 120 may communicate with the central server 200 over a wireless personal area network (WPAN) using, for example, Bluetooth techniques, the remote terminal 100 may communicate with the information management server 200 over a wireless wide area network (WWAN), for example, in accordance with EDGE, or some other 2.5G wireless communication protocol. It should be understood that according to various embodiments, any of a variety of combinations of network types and/or capabilities may be employed, as may be desirable for particular applications.

According to various embodiments, in addition to receiving data from one or more of the remote terminals 100 and/or the information management server 200, the one or more data acquisition devices 120 may be further configured to collect and transmit data on its own. For example, according to certain embodiments, the one or more data acquisition devices 120 may include a camera and/or scanner for providing data in the form of the non-limiting examples of medical records, prescription requests, and/or referral documentation. In particular embodiments, this camera and/or scanner may be used to gather information regarding any of a variety of items, which may then be used by one or more program modules, as will be described in further detail below.

The one or more data acquisition devices 120 may be any device associated with a service provider (e.g., a veterinarian clinic, a specialty hospital, a medical laboratory, etc.). In various embodiments, the one or more data acquisition devices 120 may be capable of receiving data via one or more input units or devices, such as a keypad, touchpad, barcode scanner, radio frequency identification (RFID) reader, interface card (e.g., modem, etc.), receiver, or the like. The one or more data acquisition devices 120 may likewise be capable of receiving data via any of a variety of wireless networks, as previously described herein. The one or more data acquisition devices 120 may further be capable of storing data to one or more volatile or non-volatile memory modules, and outputting the data via one or more output units or devices, for example, by displaying data to the user operating the device, or by transmitting data, for example over the one or more networks 130. In certain embodiments, the one or more data acquisition devices 120 may also be capable of manipulating and/or comparing received or transmitted data, as will be described in further detail below.

The one or more remote terminals 100, in various embodiments, may be any device capable of receiving data via one or more input units or devices, such as a keypad, touchpad, barcode scanner, RFID, interface card (e.g., modem, etc.), or receiver. The one or more remote terminals 100 may likewise be capable of receiving data via any of a variety of wireless networks, as previously described herein. The one or more remote terminals 100 may further be capable of storing data to one or more volatile or non-volatile memory modules, and outputting the data via one or more output units or devices, for example, by displaying data to the user(s) operating the one or more terminals 100, or by transmitting data, for example, over the one or more networks 130. In certain embodiments, one or more of the remote terminals 100 is associated with a patient (or patient owner) at a location remote from the information management server 200. In these and still other embodiments, one or more of the remote terminals 100 is associated with a referral party, a pharmacy, an insurance carrier, a laboratory facility, a specialty hospital facility, and/or any of a variety of third party entities having access to the one or more networks 130, all also at one or more locations physically remote from the information management server 200.

The one or more data acquisition devices 120, the information management server 200, and the one or more remote terminals 100 are illustrated in FIG. 1 according to various embodiments as being distributed relative to one another and communicating with one another over the same one or more networks 130. In certain embodiments, at least some portion of the data acquisition devices 120 may be located at one or more general practice veterinarian clinics while others may be likewise located at specialty hospitals and/or university facilities. In these embodiments, the various data acquisition devices 120 may communicate with each other and transfer any of a variety of data there-between over the one or more networks 130, as will be described in further detail below. In these and other embodiments, at least some portion of the remote terminals 100 may similarly be distributed between the general practice veterinarian clinics, specialty hospitals, university facilities, and/or patient/owner's homes. In still other embodiments, one or more of the at least one remote terminal 100 and/or data acquisition device 120 may be portably transported and remotely accessed by any one of the general practice veterinarians, specialty hospital personnel, university personnel, and/or the patient owner, as may be desirable or commonly appropriate for a particular application. Still further, any of the one or more networks 130 may be comprised of any of a variety of known and commonly used wired and/or wireless network configurations, as previously described herein or as otherwise commonly known and understood in the art.

The information management server 200 illustrated in FIG. 1 according to various embodiments may be located at a facility owned and operated by a third party provider of the system 5, thereby permitting access to various modules of the system (as will be described in further detail later) on a subscription-fee basis. In certain embodiments, however, it may be preferable to physically locate the information management server 200 at a client facility, such as the non-limiting examples of a specialty hospital and/or a university facility. In at least one embodiment, as may be desirable for a particular application, the information management server 200 may be located at a specialty hospital, such that the specialty hospital's personnel, together with general practice veterinarian clinics and/or patient owner's associated with the specialty hospital may access the system 5 conveniently. Notably, while the information management server 200 illustrated in FIG. 1 according to various embodiments may be located at a single location, it may likewise be distributed at multiple locations, as may be desirable for a particular application. Still further, it should be understood that any of a variety of physical distributions of not only the information management server 200, but also the related remote terminals 100 and/or data acquisition devices 120 of the system 5 may be envisioned as within the scope of various embodiments of the present invention, as may be desirable for various applications.

### III. EXEMPLARY SERVER ARCHITECTURE

In various embodiments, the information management server 200 includes various systems for performing one or more functions in accordance with embodiments of the present invention, including those more particularly shown and described herein. It should be understood, however, that the information management server 200 might include a variety of alternative devices for performing one or more like functions, without departing from the spirit and scope of the present invention. For example, at least a portion of the information management server 200, in certain embodiments, may be located on the one or more data acquisition devices 120 and/or the one or more remote terminals 100.

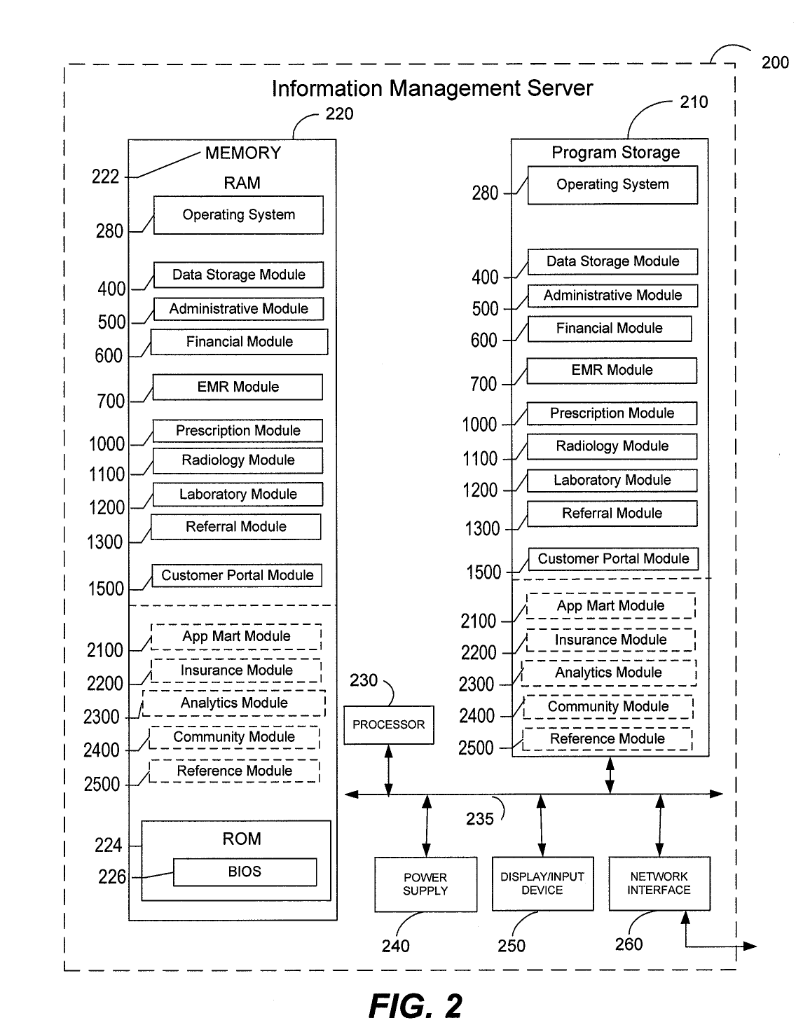

FIG. 2 is a schematic diagram of the information management server 200 according to various embodiments. The information management server 200 includes at least one processor 230 that communicates with other elements within the server via a system interface or bus 235. Also included in the information management server 200 is at least one display/input device 250 for receiving and displaying data. This display/input device 250 may be, for example, a keyboard or pointing device that is used in combination with a monitor. The information management server 200 further includes a memory 220, which preferably includes both read only memory (ROM) 224 and random access memory (RAM) 222. The server's ROM 224 is used to store a basic input/output system 226 (BIOS), containing the basic routines that help to transfer information between elements within the information management server 200.

In addition, the information management server 200 includes one or more storage devices 210, such as a hard disk drive, a floppy disk drive, a CD Rom drive, or optical disk drive, for storing information on various computer-readable media, such as a hard disk, a removable magnetic disk, or a CD-ROM disk. As will be appreciated by one of ordinary skill in the art, each of these storage devices 210 are connected to the system bus 235 by an appropriate interface. The storage devices 210 and their associated computer-readable media provide nonvolatile storage for the central server. As will be appreciated by one of ordinary skill in the art, the computer-readable media described above could be replaced by any other type of computer-readable media known in the art. Such media include, for example, magnetic cassettes, flash memory cards, digital video disks, Bernoulli cartridges, and the like, as commonly known and understood in the art.

Also located within the information management server 200 is a network interface 260 for interfacing and communicating with other elements of the one or more networks 130. It will be appreciated by one of ordinary skill in the art that one or more of the central server 200 components may be located geographically remotely from other information management server 200 components. Furthermore, one or more of the information management server 200 components may be combined, and/or additional components performing functions described herein may also be included in the information management server 200.

While the foregoing describes a single processor 230, as one of ordinary skill in the art will recognize, the information management server 200 may comprise multiple processors operating in conjunction with one another to perform the functionality described herein. In addition to the memory 220, the processor 230 can also be connected to at least one interface or other devices capable of displaying, transmitting and/or receiving data, content or the like. In this regard, the interface(s) can include at least one communication interface or other devices for transmitting and/or receiving data, content or the like, as well as one or more user interface that can include a display and/or a user input interface. The user input interface, in turn, can comprise any of a number of devices allowing the entity to receive data from a user, such as a keypad, a touch display, a joystick or other input device.

While reference is made to an information management “server” 200, as one of ordinary skill in the art will recognize, embodiments of the present invention are not limited to a client-to-server architecture. The system of various embodiments of the present invention is further not limited to a single server, or similar network entity or mainframe computer system. Other similar architectures including one or more network entities operating in conjunction with one another to provide the functionality described herein may likewise be used without departing from the spirit and scope of embodiments of the present invention. For example, a mesh network of two or more personal computers (PCs), similar electronic devices, or handheld portable devices, collaborating with one another to provide the functionality described herein in association with the information management server 200 may likewise be used without departing from the spirit and scope of embodiments of the present invention. Still further, if distributed, the information management server(s) 200 may be physically positioned at any of a variety of locations, including the non-limiting examples of a veterinarian clinic, a specialty hospital, an insurance company, or any of a variety of alternative locations, as may be desirable for a particular application.

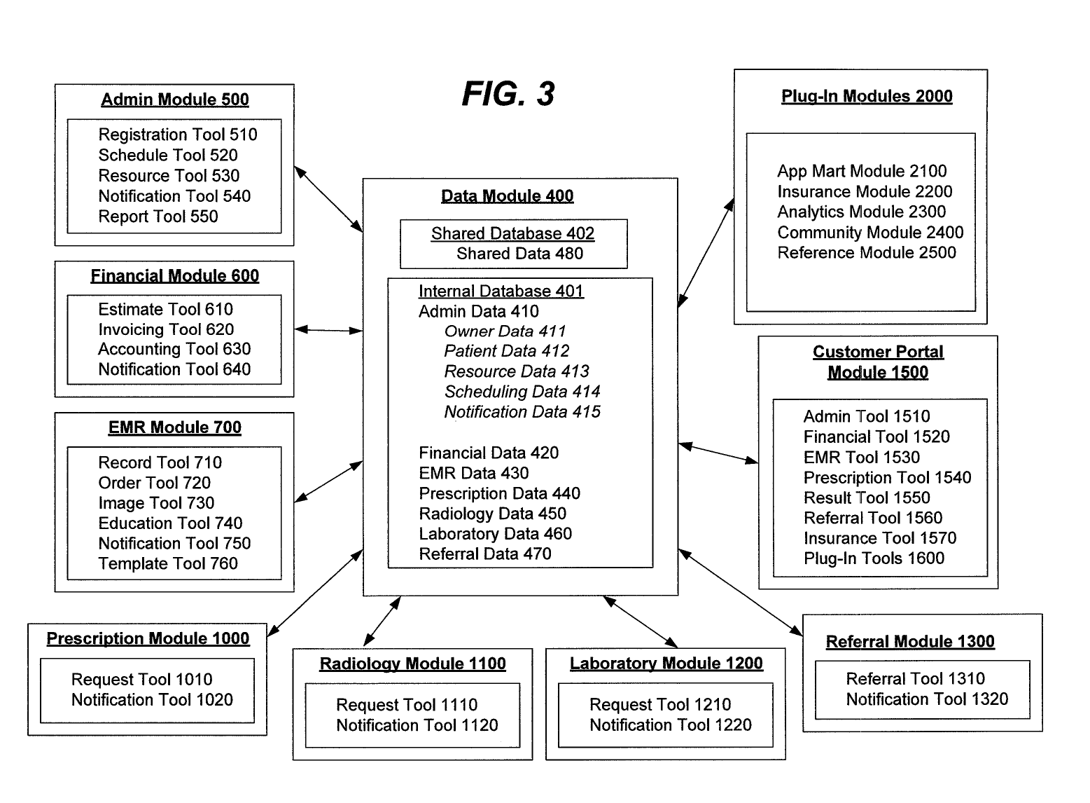

As illustrated in FIG. 2, a number of program modules may also be located within the information management server 200. The program modules may be stored by the various storage devices 210 and within RAM 222. According to various embodiments, such program modules may include an operating system 280, a data module 400, an administrative module 500, a financial module 600, an electronic medical record (EMR) module 700, a prescription module 1000, a radiology module 1100, a laboratory module 1200, a referral module 1300, and a customer portal module 1500. Certain embodiments may further include one or more additional plug-in modules 2000 (see FIG. 3), including the non-limiting examples of an App Mart module 2100, an insurance module 2200, an analytics module 2300, a community module 2400, and a reference module 2500. At least one embodiment may include only the data module 400, the administrative module 500, the financial module 600, the electronic medical record (EMR) module 700, the prescription module 1000, and the customer portal module 1500, as may be desirable for a particular application. According to any of these and still other embodiments, the various modules control certain aspects of the operation of the information management server 200 with the assistance of at least the processor 230 and the operating system 280.

FIG. 3 is a schematic block diagram of how the various modules stored by the various storage devices 210 of the information management server 200 interact with one another. In various embodiments, the data module 400 is configured to receive and store a variety of data including the non-limiting examples of admin data 410, financial data 420, EMR data 430, prescription data 440, radiology data 450, laboratory data 460, referral data 470, and/or shared data 480. As will be described in further detail below, the admin data 410 may include, for example, owner data 411, patient data 412, resource data 413, scheduling data 414, and/or notification data 415. In certain embodiments, the shared data 480 may include any of a variety of combinations or subsets of the admin data 410, financial data 420, EMR data 430, prescription data 440, radiology data 450, laboratory data 460, and/or referral data 470, as may be desirable for sharing with other users of the system 5. In at least one embodiment, the shared data 480 may be stored in a shared database 402, separate and distinct from an internal database 401 so as to minimize and/or eliminate inadvertent release of sensitive patient and/or owner data. In this and still other embodiments, certain users of the system 5 and certain modules (e.g., the analytics module 2300 and the community module 2400) may only have access to the shared database 402 and not the internal database 401 of the data module 400, again as may be desirable for a particular application.

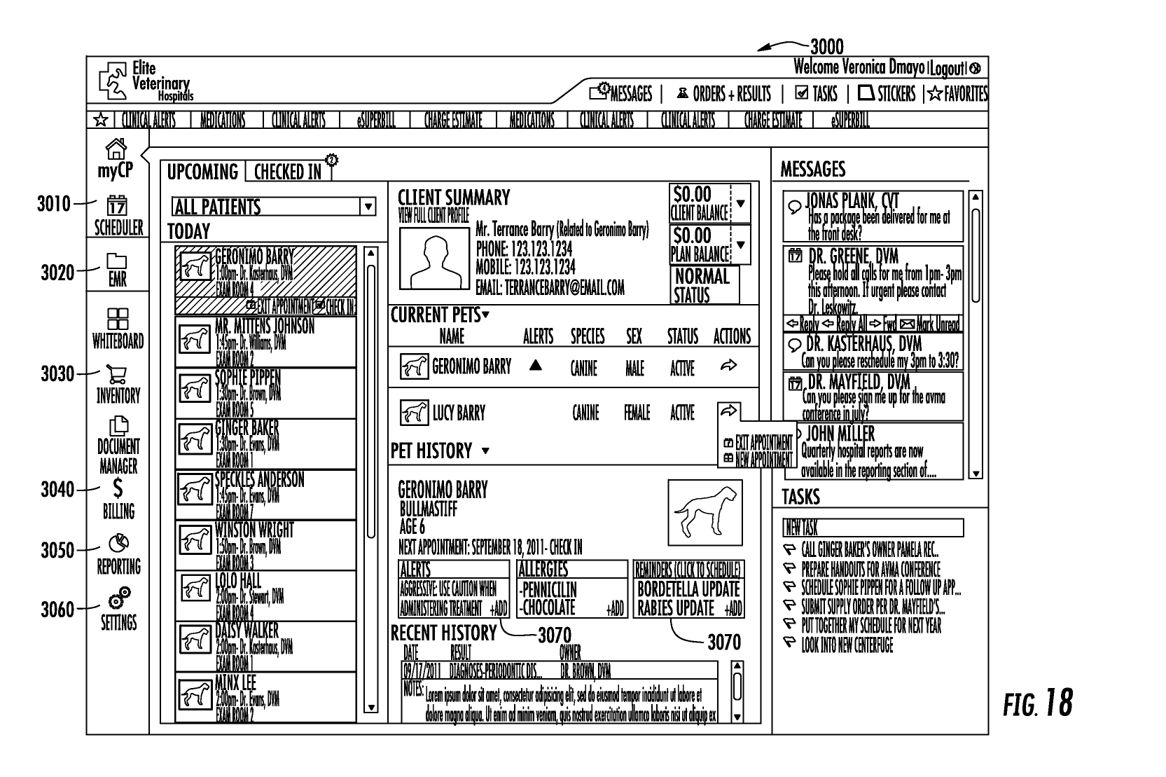

In various embodiments, the admin module 500 is configured to activate one or more of a registration tool 510, a schedule tool 520, and/or a resource tool 530 to receive, via any of a variety of input devices (e.g., 100, 120, etc.), one or more types of the admin data 410, as described immediately above. In certain embodiments, each of the respective tools is further configured to exchange (e.g., send and/or receive) various portions of the admin data 410 with the data module 400, either automatically or upon request. As will be described in further detail below, in particular embodiments, the respective tools are activated by a user directly accessing the admin module 500, while in other embodiments, the respective tools may be configured to be activated via a dashboard or “home-page” screen display 3000 (see FIG. 18) providing access to multiple such modules. Still further, according to various embodiments, the admin data 410 received via the admin module 500 may be transmitted further (e.g., beyond the data module 400) to various modules such as the financial module 600, the EMR module 700, the prescription module 1000, the radiology module 1100, the laboratory module 1200, the referral module 1300, the customer portal module 1500, and/or one or more additional plug-in modules 2000, as may be desirable for a particular application.

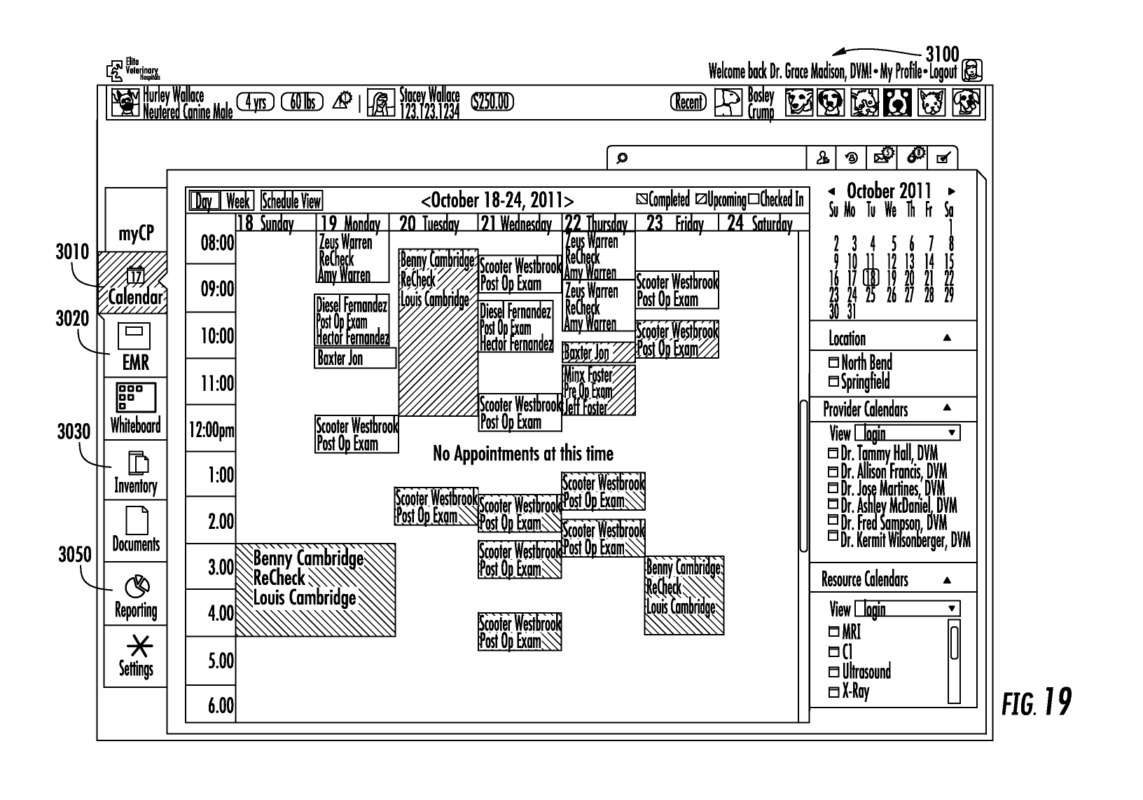

As will be described in further detail below, it should be understood that various embodiments of the admin module 500 may be configured to track all resources (e.g., exam rooms, labs, etc.) and schedules (e.g., appointments, reminders, follow-ups) of a front office of a veterinarian clinic or specialty hospital, as may be the case for particular applications. In certain embodiments, features of the admin module 500 may include user-defined scheduling templates with adjustable time increments, support for appointment conflict checking, calendar searching capabilities, and notification of patient account status at the time of scheduling, as may be understood at least in part from the scheduling screen display 3100 of FIG. 19.

Returning to FIG. 3, in various embodiments, the financial module 600 is configured to activate one or more of an estimate tool 610, an invoicing tool 610, and/or an accounting tool 630 to receive, via any of the aforementioned input devices, one or more types of financial data 420. In certain embodiments, each of the respective tools is further configured to exchange at least portions of the financial data 420 with the data module 400, either automatically or upon request. As will be described in further detail below, in particular embodiments, the respective tools are activated by a user directly accessing the financial module 600, while in other embodiments, the respective tools may be configured to be activated via the dashboard or “home-page” screen display 3000 illustrated in FIG. 18. Still further, according to various embodiments, various portions of the financial data 420 may be transmitted to various modules such as the admin module 500, the EMR module 700, the prescription module 1000, the radiology module 1100, the laboratory module 1200, the referral module 1300, the customer portal module 1500, and/or one or more additional plug-in modules 2000, as may be desirable for a particular application.

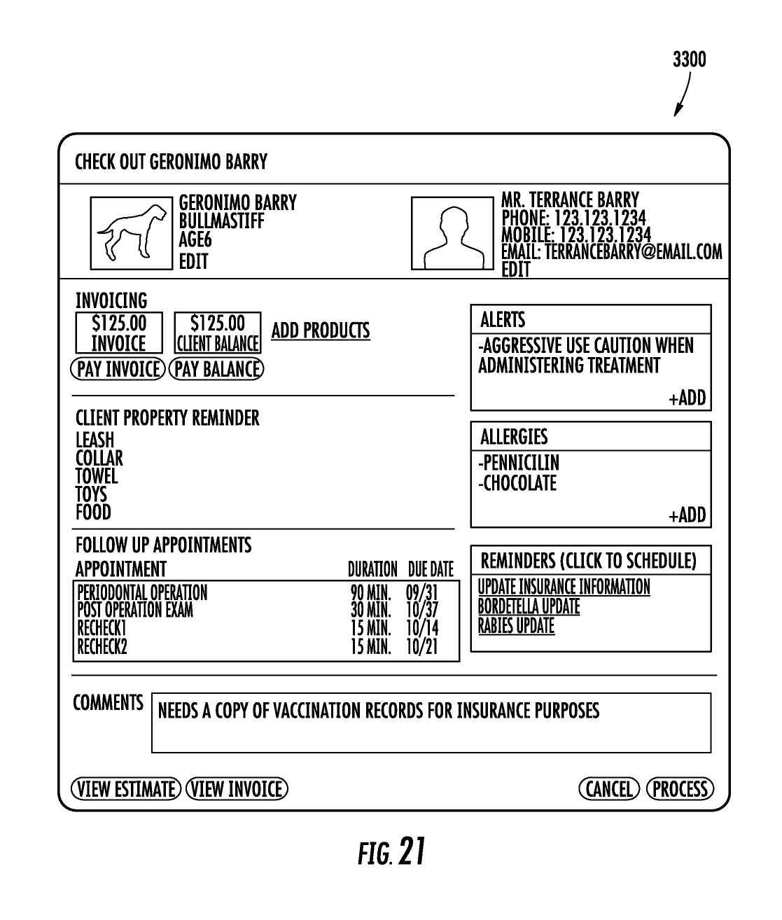

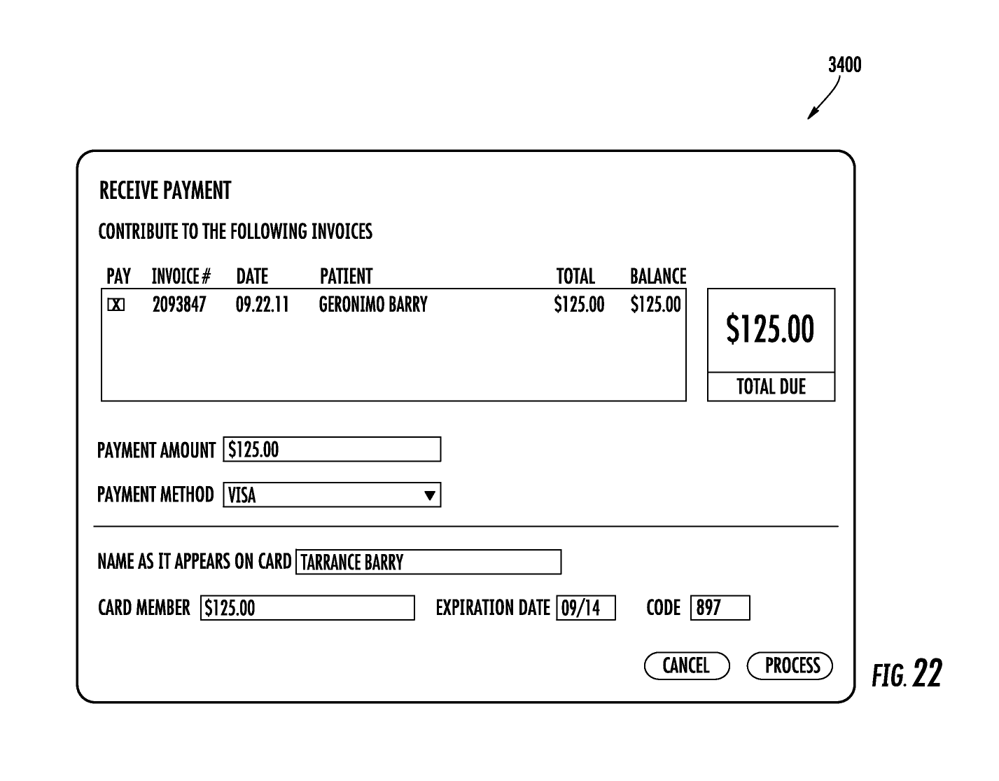

As will be described in further detail below, it should be understood that various embodiments of the tools of the financial module 600 may be configured to simplify the process of estimating charges with pre-built templates configured to automatically retrieve cost information for regularly performed procedures, as may be the case for particular applications. In certain embodiments, capabilities of the various tools of the financial module 600 may include auto-generated invoices and invoice notifications (e.g., to the customer portal module 1500 or otherwise), as may be understood at least in part from the financial screen display 3300 of FIG. 21. Still further, as may be understood with reference to the payment screen display 3400 of FIG. 22, various tools of the financial module 600 may be further configured to seamlessly process incoming payments from customers, appropriately applying them to previously generated invoices without the need for independent and/or manual accounting procedures external to the system 5.

In various embodiments, the EMR module 700 is configured to activate one or more of a record tool 710, an order tool 720, an image tool 730, and/or an education tool 740 to receive, via any of the aforementioned input devices, one or more types of EMR data 430. The EMR data 430 may be any of a variety of data stored within the data module 400, even, in particular embodiments, incorporating some portion of at least the admin data 410 and financial data 420 previously described herein. In certain embodiments, each of the respective tools is further configured to exchange at least portions of the EMR data 430 with the data module 400, either automatically or upon request. As will be described in further detail below, in particular embodiments, the respective tools are activated by a user directly accessing the EMR module 700, while in other embodiments, the respective tools may be configured to be activated via the dashboard or “home-page” screen display 3000 previously described herein. Still further, according to various embodiments, various portions of the EMR data 430 may be transmitted to various modules such as the admin module 500, the financial module 600, the prescription module 1000, the radiology module 1100, the laboratory module 1200, the referral module 1300, the customer portal module 1500, and/or one or more additional plug-in modules 2000, as may be desirable for a particular application.

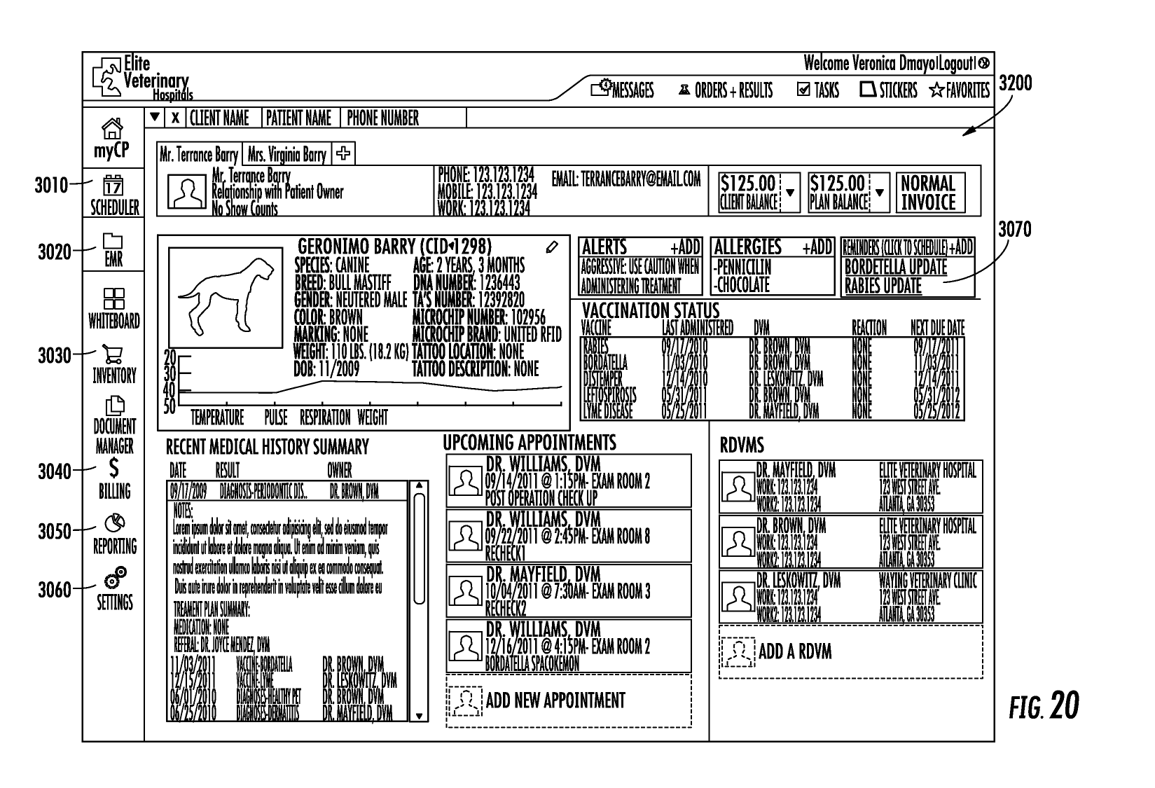

It should be understood that, in various embodiments, the EMR module 700 may be further configured to activate a template tool 760 to create and/or save customized templates for recording, maintaining, and accessing any of the variety of data otherwise available to the EMR module 700, as previously described herein. In certain embodiments, the template tool 760 may be used to create customized displays such as the non-limiting exemplary EMR screen display 3200 illustrated in FIG. 20. Such displays may be configured to not only display particular portions of the data stored within the data module 400, but also to display the selected portions in a particular manner, as may be seen in the frame display 3200 of FIG. 20. Of course, it should be understood that a user of the system 5 may activate the template tool 760 to customize the EMR module 700 so as to maximize the efficiency and effectiveness of data handling in the user's veterinarian care practice. For example, the EMR module 700 may be customized not only to electronically manage integrated prescriptions, orders, appointments, and the like, but it may also be configured to receive documentary information (e.g., an image of a patient's injury, via a scan or image-capture process) from a customer or patient, as may be desirable for particular applications.

Returning to FIG. 3, in various embodiments, the prescription module 1000 is configured to activate at least a request tool 1010 and a notification tool 1020 to exchange prescription data 440, which may incorporate at least some portion of the admin data 410, financial data 420, and/or EMR data 430, as previously described herein. In certain embodiments, the request tool 1010 is further configured to exchange at least portions of the prescription data 440 with the data module 400, either automatically or upon request. In these and still other embodiments, the previously identified notification tool 1020 may be configured to generate any of a variety of alerts and/or reminders (e.g., automatic dosage, frequency, units, refill status, etc.) for users of the system 5, as may likewise be desirable for particular applications.

As will be described in further detail below, in particular embodiments, the request tool 1010 is activated by a user directly accessing the prescription module 1000, while in other embodiments, the request tool 1010 may be configured to be activated via the dashboard or “home-page” screen display 3000 illustrated in FIG. 18. Still further, according to various embodiments, various portions of the prescription data 440 may be transmitted to various modules such as the admin module 500, the financial module 600, the EMR module 700, the radiology module 1100, the laboratory module 1200, the referral module 1300, the customer portal module 1500, and/or one or more additional plug-in modules 2000, as may be desirable for a particular application. In certain embodiments, various portions of the prescription data 440 may further be transmitted directly to a third party pharmacy facility, either automatically or upon request, as may be desirable for particular applications.

Returning to FIG. 3, in various embodiments, the radiology module 1100 is configured to activate at least a request tool 1110 and a notification tool 1120 to exchange radiology data 450, which may incorporate at least some portion of the admin data 410, financial data 420, and/or EMR data 430, as previously described herein. In certain embodiments, the request tool 1110 is further configured to exchange at least portions of the radiology data 450 with the data module 400, either automatically or upon request. In these and still other embodiments, the previously identified notification tool 1120 may be configured to generate any of a variety of alerts and/or reminders (e.g., order tracking, scheduling, radiology reporting and image tracking, etc.) for users of the system 5, as may likewise be desirable for particular applications.

As will be described in further detail below, in particular embodiments, the request tool 1110 is activated by a user directly accessing the radiology module 1100, while in other embodiments, the request tool 1110 may be configured to be activated via the dashboard or “home-page” screen display 3000 illustrated in FIG. 18. Still further, according to various embodiments, various portions of the radiology data 450 may be transmitted to various modules such as the admin module 500, the financial module 600, the EMR module 700, the referral module 1300, the customer portal module 1500, and/or one or more additional plug-in modules 2000, as may be desirable for a particular application. In certain embodiments, various portions of the radiology data 450 may further be transmitted directly to a specialized radiology facility, either automatically or upon request, as may be desirable for particular applications.

Returning to FIG. 3, in various embodiments, the laboratory module 1200 is configured to activate at least a request tool 1210 and a notification tool 1220 to exchange laboratory data 460, which may incorporate at least some portion of the admin data 410, financial data 420, and/or EMR data 430, as previously described herein. In certain embodiments, the request tool 1210 is further configured to be fully integrated with at least the EMR module 700, thereby enabling electronic orders for laboratory tests and the like to be automatically tagged with appropriate codes and transmitted to selected (or even pre-selected) laboratories. In these and still other embodiments, the previously identified notification tool 1220 may further be configured to generate any of a variety of alerts and/or reminders (e.g., test request, test status, collaboration requests, etc.) for any of the variety of users of the system 5, as may likewise be desirable for particular applications.

As will be described in further detail below, in particular embodiments, the request tool 1210 is activated by a user directly accessing the laboratory module 1200, while in other embodiments, the request tool 1210 may be configured to be activated via the dashboard or “home-page” screen display 3000 illustrated in FIG. 18. Still further, according to various embodiments, various portions of the laboratory data 460 may be transmitted to various modules such as the admin module 500, the financial module 600, the EMR module 700, the referral module 1300, the customer portal module 1500, and/or one or more additional plug-in modules 2000, as may be desirable for a particular application. In certain embodiments, various portions of the laboratory data 460 may further be transmitted directly to a specialized laboratory (e.g., testing) facility, either automatically or upon request, as may be desirable for particular applications.

Returning to FIG. 3, in various embodiments, the referral module 1300 is configured to activate at least a referral tool 1310 and a notification tool 1320 to exchange referral data 470, which may incorporate at least some portion of the admin data 410, financial data 420, EMR data 430, prescription data 440, radiology data 450, and/or laboratory data 460, as previously described herein. In certain embodiments, the request tool 1310 in this manner provides bi-directional communication between veterinarian and the referral recipient, even permitting participating users to securely access a patient's complete care delivery information over the internet (e.g., via an exchange of data between the EMR module 700 and the referral module 1300), either automatically or upon request. In these and still other embodiments, a notification tool 1320 may be configured to generate any of a variety of alerts and/or reminders (e.g., notice to patient of referral recipient contact information) for users of the system 5, as may likewise be desirable for particular applications.

As will be described in further detail below, in particular embodiments, the referral tool 1310 is activated by a user directly accessing the referral module 1300, while in other embodiments, the referral tool 1310 may be configured to be activated via the dashboard or “home-page” screen display 3000 illustrated in FIG. 18. Still further, according to various embodiments, various portions of the referral data 470 may be transmitted to various modules such as the EMR module 700, the customer portal module 1500, and/or one or more additional plug-in modules 2000, as may be desirable for a particular application. In certain embodiments, various portions of the referral data 470 may further be transmitted directly to a pre-determined referral-receiving facility, either automatically or upon request, as may be desirable for particular applications.

Returning to FIG. 3, in various embodiments, the customer portal module 1500 is configured to activate one or more of an admin tool 1510, a financial tool 1520, an EMR tool 1530, a prescription tool 1540, a result tool 1550, a referral tool 1560, an insurance tool 1570, and/or a plug-in tool 1600 to inquire regarding one or more types of data stored within the data module 400. The requested data may be any of a variety of data stored within the data module 400, as a user of the customer portal module 1500 is according to various embodiments the owner of the patient (e.g., animal treated by the veterinarian clinic). In certain embodiments, the customer portal module 1500 is further configured to receive additional data, such as the non-limiting example of electronic payment data when authorized against an outstanding invoice by the user of the customer portal module 1500. Notably, however, the customer portal module 1500 provides direct vet-to-customer communication via the internet in a seamless and transparent manner, further enabling veterinarian clinics to transmit any of a variety of approved content and links for patient education and/or information purposes.

As will be described in further detail below, in particular embodiments, the respective tools are activated by a user directly accessing the customer portal module 1500, while in other embodiments, the respective tools may be configured to be activated via a version of the dashboard or “home-page” screen display 3000 illustrated in FIG. 18 and as may be replicated and modified for a customer user (versus a veterinarian user) for particular applications. It should be understood, however, that various embodiments of the customer portal module 1500 may contain a plurality of tools (e.g., as previously described), each configured to communicate with and exchange data there-between with any combination of the modules illustrated in FIG. 3. In this manner, fluid and transparent multi-directional electronic communication (e.g., via the one or more networks 130) is provided by the system 5 between not only the personnel of the veterinarian clinic, but also the patient's owner and various other third party users such as the non-limiting examples of specialty hospital personnel, laboratory personnel, pharmacy personnel, and referred physician personnel. Still further, inefficiencies such as multiple recordation of medical-related data are avoided, which in turn greatly minimize the opportunity for error and/or inaccuracy to enter the system 5, as previously discussed herein.

Returning again to FIG. 3, in various embodiments, one or more additional plug-in modules 2000 may be provided, such as the non-limiting examples of an App Mart module 2100, an insurance module 2200, an analytics module 2300, a community module 2400, and/or a reference module 2500. Each of these modules may be configured similar to those modules previously described herein, with one or more tools accessible by any of a variety of users of the system 5. Of course, it should be understood that certain of the additional plug-in modules 2000, like those previously described herein, may have use restrictions placed thereon, whether for data privacy and security reasons or otherwise. Each of these additional plug-in modules 2000 will now be briefly described in further detail.

As will be described in further detail below, the App Mart module 2100 according to various embodiments is configured to provide an application ecosystem enabled via, for example, Software Development Kits (SDKs) and Application Programming Interfaces (APIs) developed for the system 5. Independent Software Venders (ISVs) and third-party application developers will be able to create applications that provide additional functionality to the system 5 beyond the core capabilities described elsewhere herein. The App Mart module 2100, unlike the variety of other modules described herein, will be hosted in the system provider's environment (e.g., not remotely for example at a veterinarian clinic or at a specialty hospital server site), thereby providing access (e.g., via the shared database 402 of the data module 400) for all users of the distributed system 5. In particular embodiments, users of the system 5 may selectively download one or more applications previously uploaded onto the App Mart module 2100 by a developer, as may be desirable for the users given particular applications. It should be understood, however, that the variety of applications that may be hosted on the App Mart module 2100 will be configured to plug seamlessly into the core system 5 described elsewhere herein, even though in certain embodiments, the ISVs and third-party developers may offer their products for sale in a marketplace of applications hosted by the App Mart module 2100.

Remaining with FIG. 3, the insurance module 2200 according to various embodiments is configured in an analogous fashion as the prescription module 1000, as previously described herein. In particular, in certain embodiments, the insurance module 2200 is configured to activate at least a request tool (not illustrated) and a notification tool (also not illustrated) to exchange owner data 411, which may incorporate at least some portion of data related to the pet insurance coverage held by the owner. In certain embodiments, the insurance module 2200 may be further configured to exchange at least portions of the owner data 411 with the data module 400, either automatically or upon request. In these and still other embodiments, the previously identified notification tool may be configured to generate any of a variety of alerts and/or reminders (e.g., insurance request status, co-pay notification, etc.) for users of the system 5, as may likewise be desirable for particular applications. It should be understood, however, that those embodiments incorporating the insurance module 2200 provide an even greater degree of efficiency and convenience, as real-time standardized and consolidated transmission and settlement of electronic transactions between veterinarian clinics, specialty hospitals, and insurers is established. Still further, various embodiments of the insurance module 2200 may be configured to provide real-time electronic processing of eligibility checks, claims, status checks, and payments, thereby introducing a degree of information exchange that would eliminate delay in insurance reimbursement processes and procedures traditionally encountered in the pet insurance marketplace.

The analytics module 2300, as also illustrated in FIG. 3, may incorporate one or more tools (not illustrated) configured to facilitate the analysis and sharing of a variety of data amongst a variety of users of the system 5. In certain embodiments, at least a portion of the internal (e.g., secure) data stored within the one or more internal databases 401 of the data module 400 may be mirrored as shared data 480 within a shared database 402, the latter of which is housed and maintained by the provider of the system (versus by the client users, such as veterinarian clinics or specialty hospitals and the like). The capabilities of the analytics module 2300 will, according to various embodiments, be fuelled by collaborative value of the administrative, financial, and clinical data aggregated across all users of the system 5, whether on a regional, national, or international basis. In certain embodiments, access to the analytics module 2300 (and in particular to the analytics-driven tools contained therein) will be provided with payment of an annual fee, while in other embodiments, tiered pricing schemes may provide access to ever more valuable layers of data, as may be desirable for particular applications. It should be understood, however, that the system 5 in this regards provides a valuable collaborative capabilities not otherwise available in the marketplace, facilitating not only improved treatment capabilities but also grant development and scholarly publication.

The community module 2400, as also illustrated in FIG. 3, may be configured according to various embodiments to supplement (or, alternatively, act as a replacement for) the analytics module 2300 previously described herein. In certain embodiments, the shared data 480 within the shared database 402 may be exchanged between not only the various modules of a particular system 5 installed at a particular veterinarian clinic or specialty hospital, but also across multiple systems 5 installed at multiple distributed locations. In these and other embodiments, the shared data 480 may be exchanged via an internet forum or other alternative medium, as may be desirable for a particular application. Still further, in various embodiments, additional shared data 480 may be acquired by the community module 2400 (e.g., as input by a user onto a forum thread or otherwise), thereby increasing the scope of shared data 480 available for all users having access to such systems 5. In at least one embodiment, access to the shared data 480 may be provided for free to users of the system(s) 5 (as compared to access to the analytics module 2300 and its corresponding tools for a fee), thereby facilitating at least a certain degree of public discourse and exchange of information amongst the veterinarian, hospital, and patient owner community of users.

Remaining with FIG. 3, the reference module 2500 may be configured according to various embodiments to provide any of the variety of users of the system(s) 5 with access to a database of veterinary terms, drug-drug and drug-food interactions, licensed journal and research articles, clinical trial information, as well as free-form consent from various sources. Access to the reference module 2500, like that of the analytics module 2300 will be made available in certain embodiments for an annual fee, while in other embodiments, access to tiered data of ever-increasing detail and/or value may be available only via a corresponding tiered-pricing structure. It should be understood, however, that users with access to the reference module 2500 may use such for a variety of purposes, including the non-limiting example of a clinical vet accessing the module via the education tool 740 (e.g., of the EMR module 700) during a patient/owner consultation for purposes of educating the owner regarding a particular treatment recommendation.

In various embodiments, one or more of the admin module 500, the financial module 600, the EMR module 700, the prescription module 1000, the radiology module 1100, the laboratory module 1200, the referral module 1300, the customer portal module 1500, and/or the variety of plug-in modules 2000 may be further configured to activate corresponding notification tools (e.g., 540, 640, 750, 1020, 1120, 1220, 1320, and 1580) to receive and transmit notification data 415 from the data module 400, as may be desirable for particular applications. As a non-limiting example, the notification tool 540 of the admin module 500 may receive and transmit to a user a pre-determined message (e.g., notification data 415) reminding the user of an upcoming appointment at 10:00 for a particular patient. As yet another non-limiting example, the notification tool 1580 of the customer portal module 1500 may receive and transmit to the user an alert that either a bill is due (e.g., as viewable via the financial tool 1520) or laboratory and/or radiology results have arrived (e.g., as viewable via the result tool 1550). It should be understood that any of a variety of notification messages (e.g., reminders, alerts, etc.) may be generated by the various described tools and transmitted via any of a variety of mediums (e.g., on-screen notification via customer portal module, secondary text message, e-mail, mobile application message, etc.), as may be customizable by users of the system 5 as desirable for particular applications.

Still further, in various embodiments, at least the admin module 500 may configured to activate an internally-focused (versus external analytics and the like, as previously described herein) report tool 550 to generate any of a variety of predetermined reports desired by a user of the system 5. As non-limiting examples, the user may access the report tool 550 to generate a reminder card for a patient having just scheduled their next appointment, generate a report analyzing a patient owner's timeliness in paying invoices generated by the invoice tool 620 as previously described herein, or generate a report analyzing the prescriptions recently distributed against those historically notated in the record tool 710 of the EMR module 700. It should be understood that the report tool 550 may be customized by a user of the system 5 to generate any of a variety of reports based upon any combination of data stored within the data module 400, as may be desirable for particular applications. And, as will be described in further detail below, the report(s) generated by the report tool 550 may be created in any of a variety of mediums (e.g., hardcopy, PDF, spreadsheet, etc.), as may be desirable for particular applications. Still further, additional modules, such as the non-limiting example of the customer portal module 1500 may have similarly configured report tools, thereby permitting any of a variety of users (e.g., customers, pet owners, veterinarians, hospital personnel) having access to the system 5 to generate such reports, as likewise may be desirable for particular applications.

### IV. SYSTEM LOGIC

### 1. Information Management Server Logic

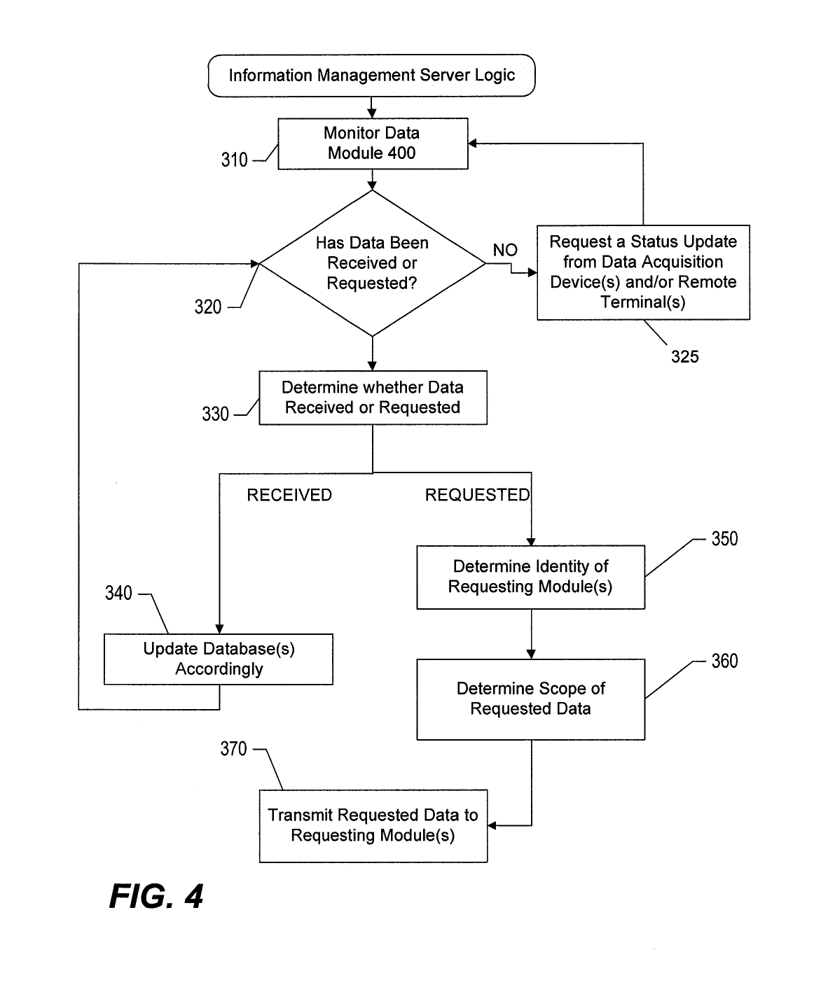

FIG. 4 illustrates steps that may be executed by the information management server 200 to oversee the exchange of data captured by the various modules (e.g., 500, 600, 700, 1000, 1100, 1200, 1300, 1500, and 2000) and received from the data acquisition devices 120 and/or the remote terminals 100 associated therewith. In various embodiments, the steps illustrated in FIG. 4 may also be executed by any of the various modules (e.g., 500, 600, 700, 1000, 1100, 1200, 1300, 1500, and 2000) and/or the data acquisition device 120 without any assistance from the information management server 200, as may be desirable for particular applications.

Beginning with step 310, the information management server 200, according to various embodiments, periodically monitors the data module 400 to assess whether any data has been received or requested from the data acquisition devices 120, the remote terminals 100, and/or any of the aforementioned remaining modules of the system 5. As a non-limiting example that will be referenced for the remainder of the disclosure, the information management server 200 may monitor the data module 400 to assess whether new appointment/scheduling data 414 has been recorded by the admin module 500 and in particular the registration and scheduling tools 510, 520, thereof. Alternative data that may have been received or requested may include owner data 411, patient data 412, resource data 413, notification data 415, financial data 420, EMR data 430, prescription data 440, radiology data 450, laboratory data 460, and/or referral data 470, each as shown in at least FIG. 3.

Returning to FIG. 4, if, during step 320, the information management server 200 determines that no data (of the exemplary types aforementioned) has been received or requested, the information management server proceeds to step 325, in which the information management server requests a status update from the data acquisition devices 120 and/or the remote terminals 100. In various embodiments, once the status update has been requested, the information management server 200 returns to steps 310 and 320 to reassess whether any data has been received at the data module 400. In one embodiment, when back at step 320 for a second time, if a data request still has not arrived, the information management server 200 will enter into a “stand-by” mode, thereby passively awaiting receipt of the data. In another embodiment, when back at step 320 for a second or subsequent time, if data still has not arrived, the information management server 200 will continually loop back through step 325 until data is received. In other embodiments (not shown), the information management server logic may be initially triggered by a message received from a data acquisition device 120, a remote terminal 100, and/or any of the plurality of modules previously described herein, as opposed to a message directly from the data module 400.

If, during step 320, the information management server 200 determines that data has been received at or requested from the data module 400, the server proceeds to step 330 and determines whether data is being input into the data module or requested therefrom. If data is being input (e.g., transferred to) the data module 400, then the information management server 200 then proceeds to step 340, during which the server updates at least the internal database 401 appropriately with the contents of the received data. Returning to our previously mentioned non-limiting example, if a new appointment is scheduled via the admin module 500, data surrounding the new appointment such as its date and time would be transmitted to the data module 400 for storage. In this non-limiting example, during step 340, the information management server 200 would identify the patient/owner record within the internal database 401 for whom the new appointment data corresponds and update that record accordingly. After having thus updated the appropriate record(s), the information management server 200 returns to step 320, during which the data module is further monitors for receipt of further data, whether incoming or requested.

If, during step 330, whether initially or otherwise, the information management server 200 determined that data is being requested from the data module 400, the server proceeds to step 350. During step 350, the server determines the identity of the requesting module, which in at least certain embodiments may be determinative of whether requested data may indeed be transmitted, as described in further detail below. Once the identity of the requesting module (e.g., one or more of the various modules as described previously herein and illustrated in at least FIG. 3) is determined, the information management server 200 may then according to various embodiments proceed to step 360, during which the actual scope and content of the requested data is determined. As a non-limiting example, it may be determined during step 360 that in addition to providing scheduling (e.g., new appointment) data to the data module 400 (as previously described), the admin module 500 may further be requesting resource data 413 (see FIG. 3) for purposes of checking any potential conflicts created by the newly scheduled appointment.

Once the scope and content of data is determined in step 360 according to various embodiments, the information management server 200 proceeds to step 370, during which the requested data is transmitted to the requesting module identified in step 350. Returning to our recurring non-limiting examples, during step 370, the information management server 200 would transmit the requested resource data 413 to the admin module 500, for it to subsequently analyze (e.g., with its resource tool 530) for purposes of avoiding a conflict when scheduling new appointment data (e.g., with its schedule tool 520). It should be understood, however, that under certain circumstances outside this non-limited and recurring example, the information management server 200 may, prior to executing the transmittal of data in step 370 have to further determine whether transmittal of the requested data is actually permitted to the requesting module. As a secondary non-limiting example, the information management server 200 may determine during step 350 that it is the customer portal module 1500 requesting owner data 411 regarding patient A, but that it is the owner of patient B logged into and accessing the customer portal module. In such instances, to preserve the security and confidentiality of patient/owner information, the information management server 200 would not transmit the requested data during step 370. Indeed, in at least one embodiment (not illustrated) the information management server 200 is configured to transmit an alert at least to the admin module 500 and the system provider if such a security or information privacy-related incident were to occur.

### 2. Admin Module Logic

According to various embodiments, the admin module 500 is configured to execute at least one or more of a registration tool 510, a schedule tool 520, a resource tool 530, a notification tool 540, and/or a report tool 550, in response to the admin module 500 being accessed by one or more users of the system 5. In certain embodiments, it should be understood that the admin module 500 provides an efficiently integrated tool for the electronic management of a medical practice (e.g., a practice management tool), for example that of a veterinarian clinic or a specialty hospital providing services in conjunction therewith. In at least some embodiments, it should further be understood that the admin module 500 may be provided remotely (e.g., via the Internet cloud), such that users of any of a variety of data acquisition devices 120 and/or remote terminals 100 at a particular veterinarian office (or otherwise) may seamlessly access the module, as may be desirable for particular applications. In still other embodiments, the admin module 500 may be provided via any of the various system architecture configurations, as previously described herein, without departing the from scope of the present invention.

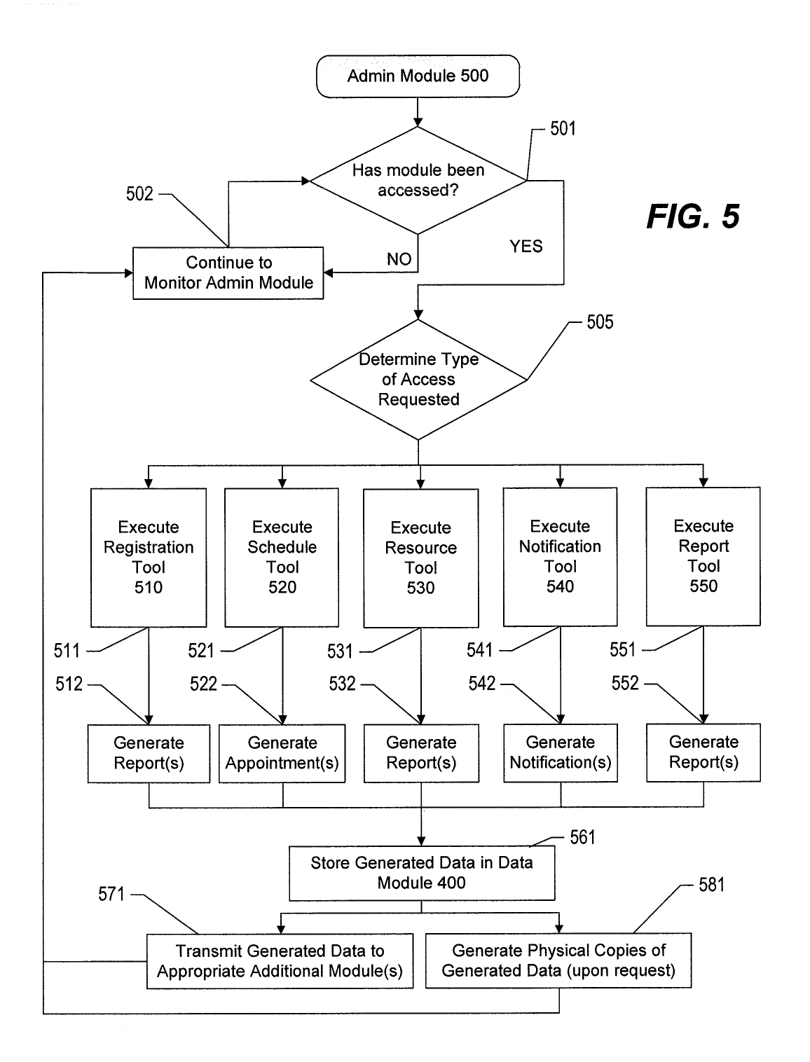

FIG. 5 illustrates steps that may be executed by the admin module 500 according to various embodiments. Beginning with step 501, the admin module 500 periodically monitors whether the module has been accessed, whether via the data acquisition devices 120, the remote terminals 100, and/or any of the aforementioned remaining modules of the system 5. If, during step 501, the admin module 500 determines that it has not been accessed, the module proceeds to step 502, in which continues to monitor itself for further access, creating an iterative loop back to step 501. If, during step 501, whether when initially there or returning iteratively, the admin module 500 determines that access has occurred, the module proceeds to step 505, during which the type of access being requested is determined according to various embodiments.

If, during step 505, it is determined that access is requested regarding registration of a new patient/owner, the admin module 500 proceeds to step 511, during which a registration tool 510 is activated and executed according to various embodiments. As may be understood from at least FIG. 18, activation and execution of the registration tool 510 may be initiated by a user of the system by navigating to the scheduling icon 3010 of the dashboard screen display 3000. Of course, it should be understood that the display 3000 of FIG. 18 is only exemplary and that in still other embodiments, the activation and execution of the registration tool 510 may occur via any of a variety of programmed display screens, as commonly known and understood in the art.

Returning to FIG. 5 and step 511, following the execution of the registration tool 510, the admin module 500 proceeds to step 512, during which a report showing the new patient/owner's registration data (e.g., at least owner data 411 and patient data 412). It should be understood that via steps 511 and 512, execution of the registration tool 510 according to certain embodiments may involve manual entry of the registration data by a user of the system, while in other embodiments at least a portion of the registration data may be automatically entered, for example by scanning a driver's license of a registrant, or otherwise. In still other embodiments, registration-related data may be transmitted to the admin module 500 via the customer portal module 1500, in for example such instances as when a customer updates their registration and/or registers with a new provider, such as a specialty hospital facility reached via a referral and the referral module 1300. It should be understood that in any of a variety of embodiments, the system 5 enables the seamless transfer of data amongst the various modules described herein, as may be desirable for particular applications.

If during step 505, it is determined that access is requested regarding scheduling of a new patient/owner appointment, the admin module 500 proceeds to step 521, during which a schedule tool 520 is activated and executed to acquire scheduling data 414 (see FIG. 3) according to various embodiments. As may be understood from at least FIG. 18, activation and execution of the schedule tool 520 may be initiated by a user of the system by navigating to the scheduling icon 3020 of the dashboard screen display 3000. Of course, it should be understood from FIG. 19, that selection of the scheduling icon 3010 according to certain embodiments may lead the user to a new scheduling screen display 3100, upon which the user may view any of a variety of data related to scheduling of appointments and/or possible conflicts, as may be desirable for particular applications. As with the various embodiments of the registration tool 510 described elsewhere herein, the admin module 500, upon execution of the schedule tool 520 during step 521 may proceed to step 522, during which a new appointment may be generated based upon at least the received scheduling data 414.

If during step 505, it is determined that access is requested regarding the availability of resources (e.g., examination rooms, supplies, etc.), the admin module 500 proceeds to step 531, during which a resource tool 530 is activated and executed to acquire resource data 413 (see FIG. 3) according to various embodiments. As may be understood from at least FIG. 18, activation and execution of the resource tool 530 may be initiated by a user of the system by navigating to the scheduling icon 3030 of the dashboard screen display 3000. Of course, it should be understood from FIG. 19, that selection of the resource icon 3030 according to certain embodiments may lead the user to a new scheduling screen display (not shown), upon which the user may view any of a variety of data related to availability of resources and/or the avenues for, for example, restocking or reassigning thereof, as may be desirable for particular applications. As with the various embodiments of the registration tool 510 described elsewhere herein, the admin module 500, upon execution of the resource tool 530 during step 531 may proceed to step 532, during which a resource order/allocation report may be generated based upon at least the received scheduling data 413.

If during step 505, it is determined that access is requested regarding the exchange of notifications (e.g., to and from the admin module 500 from any of the variety of remaining modules as described elsewhere herein), the admin module 500 proceeds to step 541, during which a notification tool 540 is activated and executed to analyze any of a variety of data within the internal database 401 of the data module 400 (see FIG. 3) according to various embodiments. As may be understood from at least FIGS. 18-21, activation and execution of the notification tool 540 may result in the display on any of a variety of screens (e.g., 3000, 3100, 3200, 3300, etc.) of various alerts and/or reminders, however as may be desirable for particular applications.

If during step 505, it is determined that access is requested regarding the availability of various reports (e.g., patient load, patient treatment, office billing management, etc.), the admin module 500 proceeds to step 551, during which a report tool 550 is activated and executed to acquire and analyze any of a variety of data contained within the data module 400 (see FIG. 3) according to various embodiments. As may be understood from at least FIGS. 18-20, activation and execution of the report tool 550 may be initiated by a user of the system by navigating to (for example) the scheduling icon 3030 of the dashboard screen display 3000 (or other exemplary display screens, such as the non-limiting examples of screens 3100 and 3200). Still further, as with the various embodiments of the registration tool 510 described elsewhere herein, the admin module 500, upon execution of the report tool 550 during step 551 may proceed to step 552, during which any of a variety of reports may be generated based upon at least the acquired, manipulated, and/or analyzed data of the data module 400.

Once one or more of the variety of tools (e.g., 510, 520, 530, 540, and/or 550) described previously herein have been executed by the admin module 500, the module according to various embodiments then proceeds to step 561, during which any data/reports generated during at least steps 512, 522, 532, 542, and 552 by the various tools is further transmitted to and stored within the data module 400. In certain embodiments, such will involve automatic updating of existing records with newly stored data, while in other embodiments, such may involve further transmitting a notification to various modules (as described elsewhere herein) prior to updating (and potentially overwriting) existing records. In these and still other embodiments, once the data is transmitted to and stored within the data module 400, the admin module 500 may be further configured to transmit the data to additional modules (see FIG. 3) and/or generate a physical copy of any generated or updated data/reports, each however as may be desirable for a particular application.

### 3. Financial Module Logic

According to various embodiments, the financial module 600 is configured to execute at least one or more of an estimate tool 610, an invoicing tool 620, an accounting tool 630, and/or a notification tool 540 in response to the financial module 600 being accessed by one or more users of the system 5. In certain embodiments, it should be understood that the financial module 600 provides an efficiently integrated tool for the electronic management of the financial accounting practices of a medical practice, including in at least certain embodiments interfacing with customer (e.g., patient/owner) insurance providers, as will be described in further detail below.

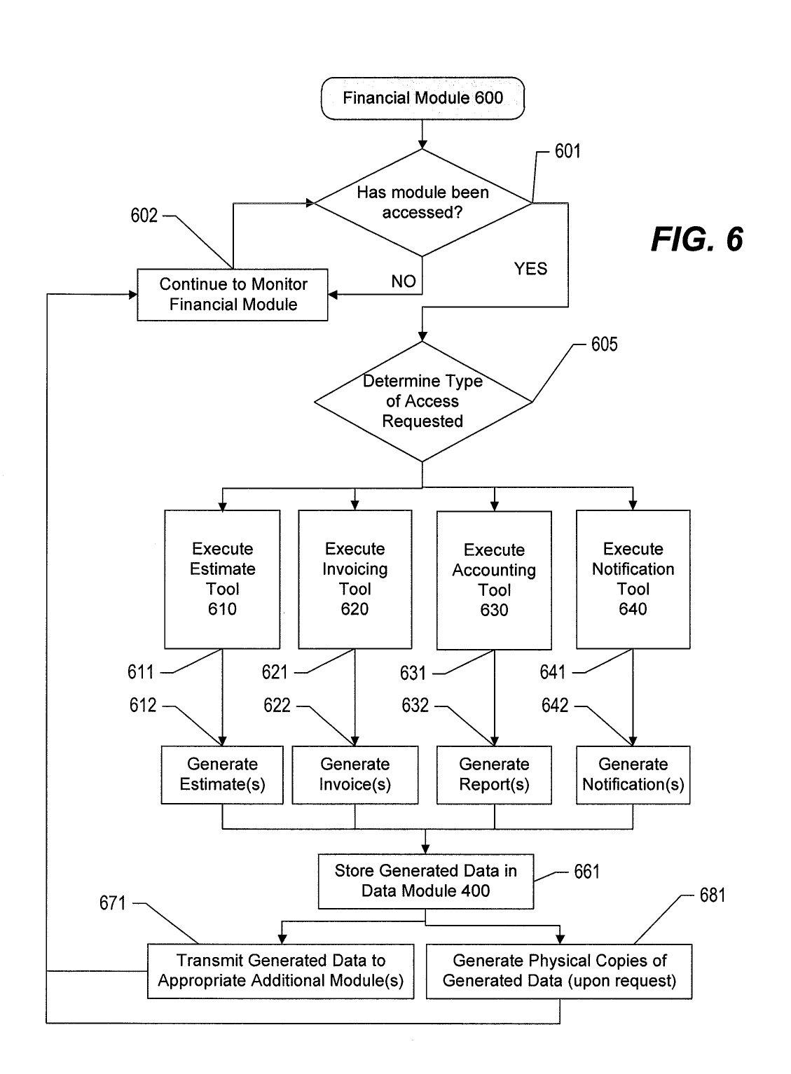

FIG. 6 illustrates steps that may be executed by the financial module 600 according to various embodiments. Beginning with step 601, the financial module 600 periodically monitors whether the module has been accessed, whether via the data acquisition devices 120, the remote terminals 100, and/or any of the aforementioned remaining modules of the system 5. If, during step 601, the financial module 600 determines that it has not been accessed, the module proceeds to step 602, in which continues to monitor itself for further access, creating an iterative loop back to step 601. If, during step 601, whether when initially there or returning iteratively, the financial module 600 determines that access has occurred, the module proceeds to step 605, during which the type of access being requested is determined according to various embodiments.

If during step 605, it is determined that access is requested regarding providing a cost estimate to a new or existing patient owner for a particular procedure or services, the financial module 600 proceeds to step 611, during which an estimate tool 610 is activated and executed to acquire financial data 420 (see FIG. 3) according to various embodiments. As may be understood from at least FIG. 18, activation and execution of the estimate tool 610 may be initiated by a user of the system by navigating to the billing/finance icon 3040 of the dashboard screen display 3000. Of course, it should be understood from FIG. 21, that selection of the billing/finance icon 3040 according to certain embodiments may lead the user to a new financial screen display 3300, upon which the user may view any of a variety of data related to financial data, as may be desirable for particular applications. The financial module 600, upon execution of the estimate tool 610 during step 611 may proceed to step 612, during which an estimate report (electronically or otherwise) may be generated based upon at least the received financial data 420.

If during step 605, it is determined that access is requested regarding sending an invoice to an existing patient owner for a particular procedure or services, the financial module 600 proceeds to step 621, during which an invoice tool 620 is activated and executed to acquire financial data 420 (see FIG. 3) according to various embodiments. As may be understood from at least FIG. 18, activation and execution of the invoice tool 620 may be initiated by a user of the system by navigating to the billing/finance icon 3040 of the dashboard screen display 3000. Of course, it should be understood from FIG. 21, that selection of the billing/finance icon 3040 according to certain embodiments may lead the user to a new financial screen display 3300, upon which the user may view any of a variety of data related to financial data, as may be desirable for particular applications. The financial module 600, upon execution of the invoice tool 620 during step 621 may proceed to step 622, during which an invoice report (electronically or otherwise) may be generated based upon at least the received financial data 420.

If during step 605, it is determined that access is requested regarding receiving a payment (e.g., performing an accounting) from an existing patient owner for a particular procedure or services, the financial module 600 proceeds to step 631, during which an accounting tool 630 is activated and executed to acquire financial data 420 (see FIG. 3) according to various embodiments. As may be understood from at least FIG. 18, activation and execution of the accounting tool 630 may be initiated by a user of the system by navigating to the billing/finance icon 3040 of the dashboard screen display 3000. Of course, it should be understood from FIG. 22, that selection of the billing/finance icon 3040 according to certain embodiments when processing a payment may lead the user to a new payment screen display 3400, upon which the user may view any of a variety of data related to financial data to appropriately apply the received payment, as may be desirable for particular applications. It should also be understood that the financial module 600 may receive accounting/payment data from the data module 400 or directly from the customer portal module 1500, as described elsewhere herein. In these and still other embodiments, however, the financial module 600, upon execution of the accounting tool 630 during step 631 may proceed to step 632, during which an invoice report (electronically or otherwise) may be generated based upon at least the received financial data 420.

If during step 605, it is determined that access is requested regarding the exchange of notifications (e.g., to and from the financial module 600 from any of the variety of remaining modules as described elsewhere herein), the financial module 600 proceeds to step 641, during which a notification tool 640 is activated and executed to analyze any of a variety of data within the internal database 401 of the data module 400 (see FIG. 3) according to various embodiments. As may be understood from at least FIGS. 18-21, activation and execution of the notification tool 640 may result in the display on any of a variety of screens (e.g., 3000, 3100, 3200, 3300, etc.) of various alerts and/or reminders, however as may be desirable for particular applications.

Once one or more of the variety of tools (e.g., 610, 620, 630, 640, etc.) described previously herein have been executed by the financial module 600, the module according to various embodiments then proceeds to step 661, during which any data/reports generated during at least steps 612, 622, 632, 642 by the various tools is further transmitted to and stored within the data module 400. In certain embodiments, such will involve automatic updating of existing records with newly stored data, while in other embodiments, such may involve further transmitting a notification to various modules (as described elsewhere herein) prior to updating (and potentially overwriting) existing records. In these and still other embodiments, once the data is transmitted to and stored within the data module 400, the financial module 600 may be further configured to transmit the data to additional modules (see FIG. 3) and/or generate a physical copy of any generated or updated data/reports, each however as may be desirable for a particular application.

### 4. EMR Module Logic

According to various embodiments, the EMR module 700 is configured to execute at least one or more of a record tool 710, an order tool 720, an image tool 730, an education tool 740, a notification tool 750, and/or a template tool 760 in response to the EMR module 700 being accessed by one or more users of the system 5. In certain embodiments, it should be understood that the EMR module 700 provides an efficiently integrated tool for the electronic management of the patient medical records, including in at least certain embodiments the capability of seamlessly interfacing with pharmacies and/or third-party referral-receiving facilities. In at least some embodiments, it should further be understood that the EMR module 700 may be provided remotely (e.g., via the Internet cloud), such that users of any of a variety of data acquisition devices 120 and/or remote terminals 100 at a particular veterinarian office (or otherwise) may seamlessly access the EMR module, as may be desirable for particular applications. In still other embodiments, the EMR module 700 may be provided via any of the various system architecture configurations, as previously described herein.

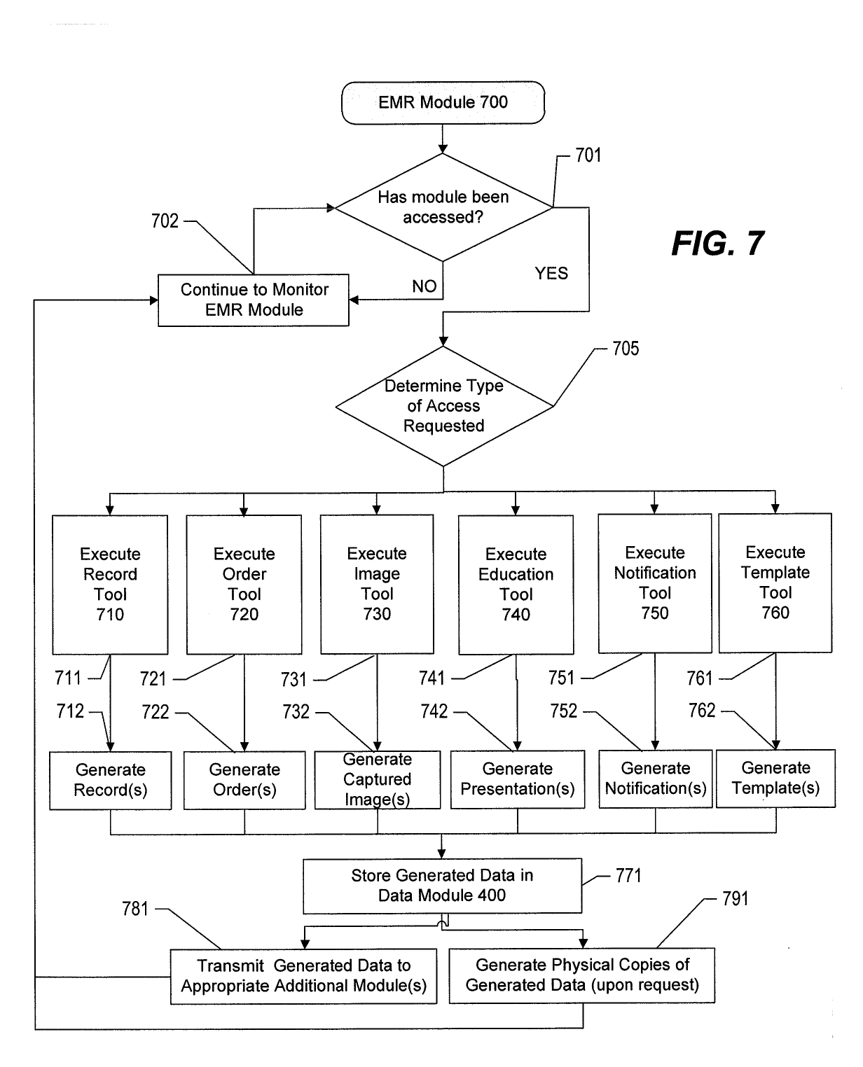

FIG. 7 illustrates steps that may be executed by the EMR module 700 according to various embodiments. Beginning with step 701, the EMR module 700 periodically monitors whether the module has been accessed, whether via the data acquisition devices 120, the remote terminals 100, and/or any of the aforementioned remaining modules of the system 5. If, during step 701, the EMR module 700 determines that it has not been accessed, the module proceeds to step 702, in which continues to monitor itself for further access, creating an iterative loop back to step 701. If, during step 701, whether when initially there or returning iteratively, the EMR module 700 determines that access has occurred, the module proceeds to step 705, during which the type of access being requested is determined according to various embodiments.

If during step 705, it is determined that access is requested regarding recording of patient medical data, the EMR module 700 proceeds to step 711, during which a record tool 710 is activated and executed to acquire EMR (e.g., medical record) data 430 (see FIG. 3) according to various embodiments. As may be understood from at least FIG. 18, activation and execution of the record tool 710 may be initiated by a user of the system by navigating to the EMR icon 3020 of the dashboard screen display 3000. Of course, it should be understood from FIG. 20, that selection of the EMR icon 3020 according to certain embodiments may lead the user to a new EMR screen display 3200, upon which the user may view any of a variety of data related to a patient's medical history, upcoming appointments, referrals, vaccinations, alerts, etc., all as may be desirable for particular applications. The EMR module 700, upon execution of the record tool 710 during step 711 may proceed to step 712, during which the new data may be captured and generated, whether manually or otherwise acquired, as may be desirable for particular applications.

If during step 705, it is determined that access is requested regarding the order of patient treatments, medications, or the like, the EMR module 700 proceeds to step 721, during which an order tool 720 is activated and executed to acquire EMR (e.g., medical record history, etc.) data 430 (see FIG. 3) according to various embodiments. As may be understood from at least FIG. 18, activation and execution of the order tool 720 may be initiated by a user of the system by navigating to the EMR icon 3020 of the dashboard screen display 3000. Of course, it should be understood from FIG. 20, that selection of the EMR icon 3020 according to certain embodiments may lead the user to a new EMR screen display 3200, upon which the user may view any of a variety of data related to a patient's medical history, upcoming appointments, referrals, vaccinations, alerts, and based upon at least that data order pertinent tests, whether laboratory, radiology, referral, or prescription related, all as may be desirable for particular applications. It should be understood that execution of the order tool 720 in certain embodiments may involve the exchange of data with at least the prescription module 1000, the radiology module 1100, the laboratory module 1200, the insurance module 2200, the referral module 1300, and/or the customer portal module 1500. In any of these and still other embodiments, the EMR module 700, upon execution of the order tool 720 during step 721 may proceed to step 722, during which the new data may be captured and generated, whether manually or otherwise acquired, as may be desirable for particular applications.

If during step 705, it is determined that access is requested regarding the electronic capture of any EMR data 420, whether via a scanner or camera within the remote terminal 100 and/or the data acquisition devices 120 or otherwise, the EMR module 700 proceeds to step 731, during which an image tool 730 is activated and executed to acquire the pertinent EMR data 430 (see FIG. 3) according to various embodiments. In any of these and still other embodiments, the EMR module 700, upon execution of the image tool 730 during step 731 may proceed to step 732, during which the new data may be captured and generated, whether manually or otherwise acquired, as may be desirable for particular applications.

If during step 705, it is determined that access is requested regarding the electronic sharing of educational data (e.g., via the reference module 2500), the EMR module 700 may proceed to step 741, during which an education tool 740 is activated and executed to acquire the pertinent educational data (e.g., treatment procedures, medication side-effects, etc.). According to various embodiments, it may be desirable for the treating physician to have immediate access to for purposes of fully explaining veterinarian care alternatives to a patient's owner on a real-time basis. In any of these and still other embodiments, the EMR module 700, upon execution of the education tool 740 during step 741 may proceed to step 742, during which any modifications to the viewed data may be captured and generated by the doctor, whether manually or otherwise acquired, as may be desirable for particular applications. For example, the treating physician may wish to print a copy of certain pages for the patient's owner after having made pertinent notations thereupon (e.g., via the data acquisition devices 120), in which case during step 742, a presentation of the education data may be generated for future use and reference.

If during step 705, it is determined that access is requested regarding the exchange of notifications (e.g., to and from the EMR module 700 from any of the variety of remaining modules as described elsewhere herein), the EMR module 700 proceeds to step 751, during which a notification tool 750 is activated and executed to analyze any of a variety of data within the internal database 401 of the data module 400 (see FIG. 3) according to various embodiments. As may be understood from at least FIGS. 18-21, activation and execution of the notification tool 750 may result in the display on any of a variety of screens (e.g., 3000, 3100, 3200, 3300, etc.) of various alerts and/or reminders, however as may be desirable for particular applications.

If during step 705, it is determined that access is requested regarding the creation or modification of any of a variety of customizable templates for displaying data via the EMR module 700, the module may proceed to step 761, during which a template tool 760 is activated and executed to acquire the pertinent customization data. Customization provides treating physicians and other users of the EMR module 700 the capability of personalizing the displays for data capture so as to more efficiently and effectively refine their particular practice. Indeed, in any of these and other embodiments, the EMR module 700, upon execution of the template tool 760 during step 761 may proceed to step 762, during which any modifications to the templates may be captured and stored by the doctor, whether manually or otherwise acquired, as may be desirable for particular applications. In still other embodiments, it should be understood that a provider of the system 5 may incorporate specialty templates within the EMR module 700, based upon commonly known and understood features that many practitioners consider desirable. In certain embodiments, the specialty templates may be further customizable by users of the system.

Once one or more of the variety of tools (e.g., 710, 720, 730, 740, 750 and/or 760) described previously herein have been executed by the EMR module 700, the module according to various embodiments then proceeds to step 761, during which any data/reports generated during at least steps 712, 722, 732, 742, 752, and 762 by the various tools is further transmitted to and stored within the data module 400. In certain embodiments, such will involve automatic updating of existing records with newly stored data, while in other embodiments, such may involve further transmitting a notification to various modules (as described elsewhere herein) prior to updating (and potentially overwriting) existing records. In these and still other embodiments, once the data is transmitted to and stored within the data module 400, the EMR module 700 may be further configured to transmit the data to additional modules (see FIG. 3) and/or generate a physical copy of any generated or updated data/reports, each however as may be desirable for a particular application.

### 5. Prescription Module Logic

According to various embodiments, the prescription module 1000 is configured to execute at least one or more of a request tool 1010 and/or a notification tool 1020 in response to the prescription module 1000 being accessed by one or more users of the system 5. In certain embodiments, it should be understood that the prescription module 1000 provides an efficiently integrated tool for the electronic transfer of information between veterinary clinics or specialty hospitals/universities, patients treated at such facilities or the owners thereof, and third-party pharmaceutical prescription-filling facilities.

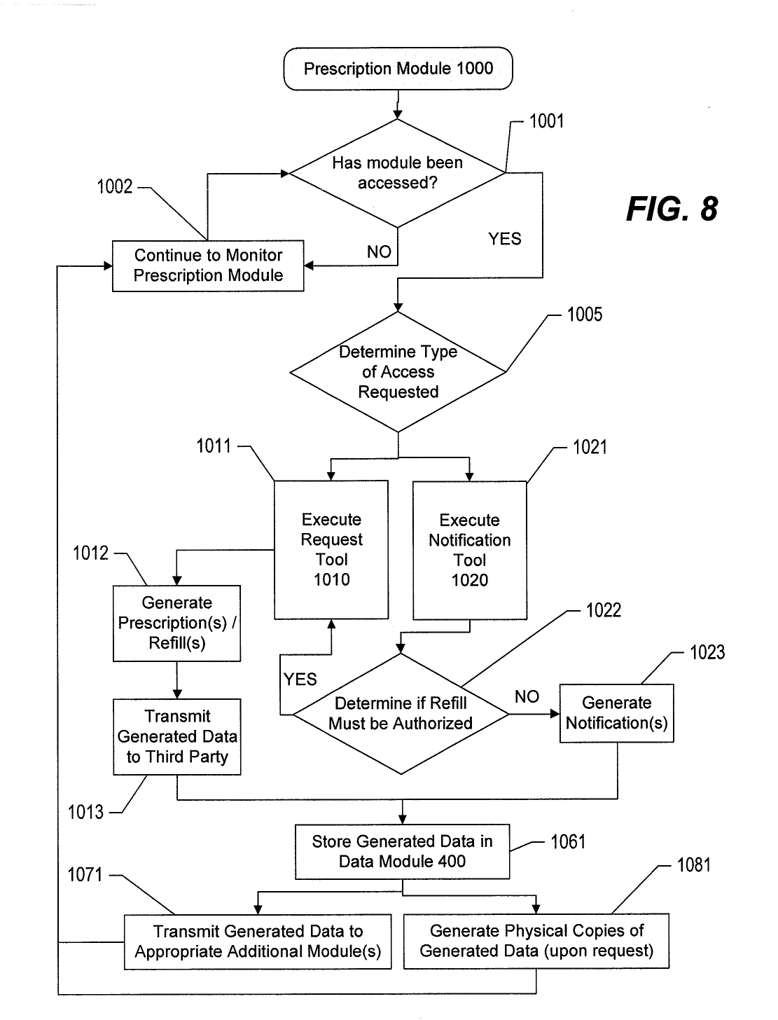

FIG. 8 illustrates steps that may be executed by the prescription module 1000 according to various embodiments. Beginning with step 1001, the prescription module 1000 periodically monitors whether the module has been accessed, whether via the data acquisition devices 120, the remote terminals 100, and/or any of the aforementioned remaining modules of the system 5. If, during step 1001, the prescription module 1000 determines that it has not been accessed, the module proceeds to step 1002, in which continues to monitor itself for further access, creating an iterative loop back to step 1001. If, during step 1001, whether when initially there or returning iteratively, the prescription module 1000 determines that access has occurred, the module proceeds to step 1005, during which the type of access being requested is determined according to various embodiments.

If, during step 1005 according to various embodiments, it was determined by the prescription module 1000 that access was requested for purposes of submitting a prescription request, the module proceeds to execute the request tool 1010 (as previously described herein) to generate a prescription order during step 1012. The prescription module 1000 according to various embodiments would then proceed to step 1013, during which the order is transmitted to an appropriate party for resolution. In these and still other embodiments, the order would then be transmitted during step 1013 to an external third-party pharmacy for fulfillment.

Once the prescription order is transmitted during step 1013, the prescription module 1000 according to various embodiments then proceeds to step 1061, during which any data generated during at least steps 1011, 1012, and 1013 by the request tool 1010 are transmitted to and stored within the data module 400. In certain embodiments, such will involve automatic updating of existing records with newly stored data, while in other embodiments, such may involve further transmitting a notification to at least the admin module 500 and the EMR module 700 prior to updating (and potentially overwriting) existing records. In these and still other embodiments, once the data is transmitted to and stored within the data module 400, the prescription module 1000 may be further configured to transmit the data to additional modules (see FIG. 3) and/or generate a physical copy of any generated or updated data, each however as may be desirable for a particular application.

Returning to FIG. 8, and in particular to step 1005 according to various embodiments of the prescription module 1000, if during that step the module determines that some sort of notification data 415 (see FIG. 3) is being requested or is warranted, the module will proceed to step 1021 instead of the previously described step 1011. During step 1021 according to various embodiments, the prescription module 1000 is configured to execute a notification tool 1020 that will, for example, determine if a refill must be authorized prior to transmittal to the third party pharmacy during step 1013. If a refill must be authorized, the prescription module 1000 then proceeds via step 1022 to request such, generally by generating a notification to that effect in step 1023. In the instance example of a refill notification, the notification generated during step 1023 could be transmitted to at least one of the admin module 500 and the EMR module 700 for immediate doctor attention and approval.

Of course, it should be understood that according to various embodiments any of a variety of notification requests could be envisioned (e.g., notice of competing prescriptions that could be risky to combine, notice of attempted unauthorized refill, notice of prescription expiration, etc.), all as may be desirable and beneficial for particular applications. In this regard, according to these and still other embodiments, for purposes of at least efficiency and accuracy, the prescription module 1000, after completing step 1023, may similarly proceed to step 1061, during which any data generated during at least steps 1021, 1022, and 1023 by the notification tool 1020 is transmitted to and stored within the data module 400, whether automatically or upon subsequent review and approval, all as previously described herein.

It should be further understood that the access of the prescription module 1000 according to various embodiments may be bi-directional, in which case, instead of a doctor accessing the module (e.g., in step 1101, as previously described herein), it is instead the external third-party pharmacy accessing the module. In certain embodiments, such access may be for purposes of notifying the prescription module 1000 that an order (or a refill) has been fulfilled and/or picked up by the patient's owner. In other embodiments, such access may further involve payment for and settlement of the charges associated with the prescription, whether via the financial module 600 and/or the insurance module 2200, both of which have been described elsewhere herein in their entirety.

### 6. Radiology Module Logic

According to various embodiments, the radiology module 1100 is configured to execute at least one or more of a request tool 1110 and/or a notification tool 1120 in response to the radiology module 1100 being accessed by one or more users of the system 5. In certain embodiments, it should be understood that the radiology module 1100 provides an efficiently integrated tool for the electronic transfer of information between veterinary clinics or specialty hospitals/universities, patients treated at such facilities or the owners thereof, and third-party radiology providing facilities.

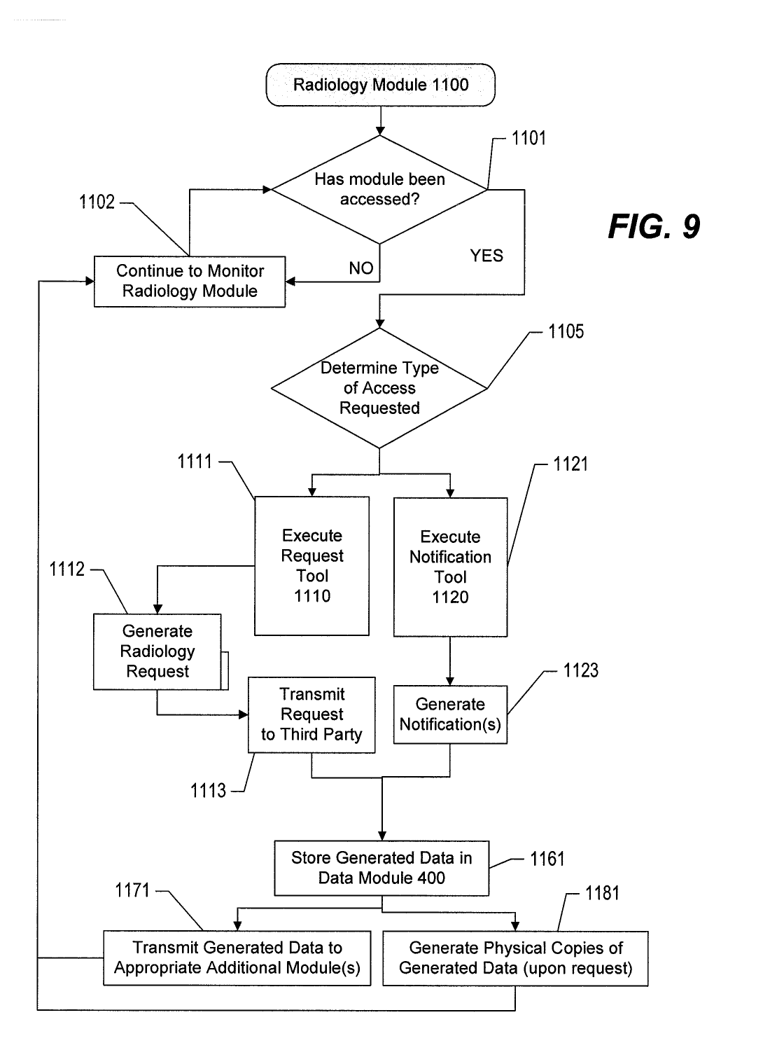

FIG. 9 illustrates steps that may be executed by the radiology module 1100 according to various embodiments. Beginning with step 1101, the radiology module 1100 periodically monitors whether the module has been accessed, whether via the data acquisition devices 120, the remote terminals 100, and/or any of the aforementioned remaining modules of the system 5. If, during step 1101, the radiology module 1100 determines that it has not been accessed, the module proceeds to step 1102, in which continues to monitor itself for further access, creating an iterative loop back to step 1101. If, during step 1101, whether when initially there or returning iteratively, the radiology module 1100 determines that access has occurred, the module proceeds to step 1105, during which the type of access being requested is determined according to various embodiments.

If, during step 1105 according to various embodiments, it was determined by the radiology module 1100 that access was requested for purposes of submitting a radiology services request, the module proceeds to execute the request tool 1110 (as previously described herein) to generate a radiology order request during step 1112. The radiology module 1100 according to various embodiments would then proceed to step 1113, during which the order is transmitted to an appropriate party (e.g., personnel at a dedicated radiology facility) for resolution.

Once the radiology request is transmitted during step 1113, the radiology module 1100 according to various embodiments then proceeds to step 1161, during which any data generated during at least steps 1111, 1112, and 1113 by the request tool 1110 is transmitted to and stored within the data module 400. In certain embodiments, such will involve automatic updating of existing records with newly stored data, while in other embodiments, such may involve further transmitting a notification to at least the admin module 500 and the EMR module 700 prior to updating (and potentially overwriting) existing records. In these and still other embodiments, once the data is transmitted to and stored within the data module 400, the radiology module 1100 may be further configured to transmit the data to additional modules (e.g., any of those illustrated in FIG. 3) and/or generate a physical copy of any generated or updated data, each however as may be desirable for a particular application.

Returning to FIG. 9, and in particular to step 1105 according to various embodiments of the radiology module 1100, if during that step the module determines that some sort of notification data 415 (see FIG. 3) is being requested or is warranted, the module will proceed to step 1121 instead of the previously described step 1111. During step 1121 according to various embodiments, the radiology module 1100 is configured to execute a notification tool 1120 configured to generate any of a variety of notifications (e.g., notice of insurance not covering a particular radiology request, notice of radiology request being completed, notice of unexpected delay in completion of request, etc.), all as may be desirable and beneficial for particular applications. In this regard, according to these and still other embodiments, for purposes of at least efficiency and accuracy, the radiology module 1100, after completing step 1123, may similarly proceed to step 1161, during which any data generated during at least steps 1121, 1122, and 1123 by the notification tool 1120 is transmitted to and stored within the data module 400, whether automatically or upon subsequent review and approval, all as previously described herein.

It should be further understood that the access of the radiology module 1100 according to various embodiments may be bi-directional, in which case, instead of the requesting doctor accessing the module (e.g., in step 1101, as previously described herein) it is instead the external third-party radiology personnel accessing the module. In certain embodiments, such access may be for purposes of notifying the radiology module 1100 that a radiology order has been completed. In other embodiments, such access may further involve payment for and settlement of the charges associated with the prescription, whether via the financial module 600 and/or the insurance module 2200, both of which have been described elsewhere herein in their entirety.

### 7. Laboratory Module Logic

According to various embodiments, the laboratory module 1200 is configured to execute at least one or more of a request tool 1210 and/or a notification tool 1220 in response to the laboratory module 1200 being accessed by one or more users of the system 5. In certain embodiments, it should be understood that the radiology module 1200 provides an efficiently integrated tool for the electronic transfer of information between veterinary clinics or specialty hospitals/universities, patients treated at such facilities or the owners thereof, and third-party radiology providing facilities.

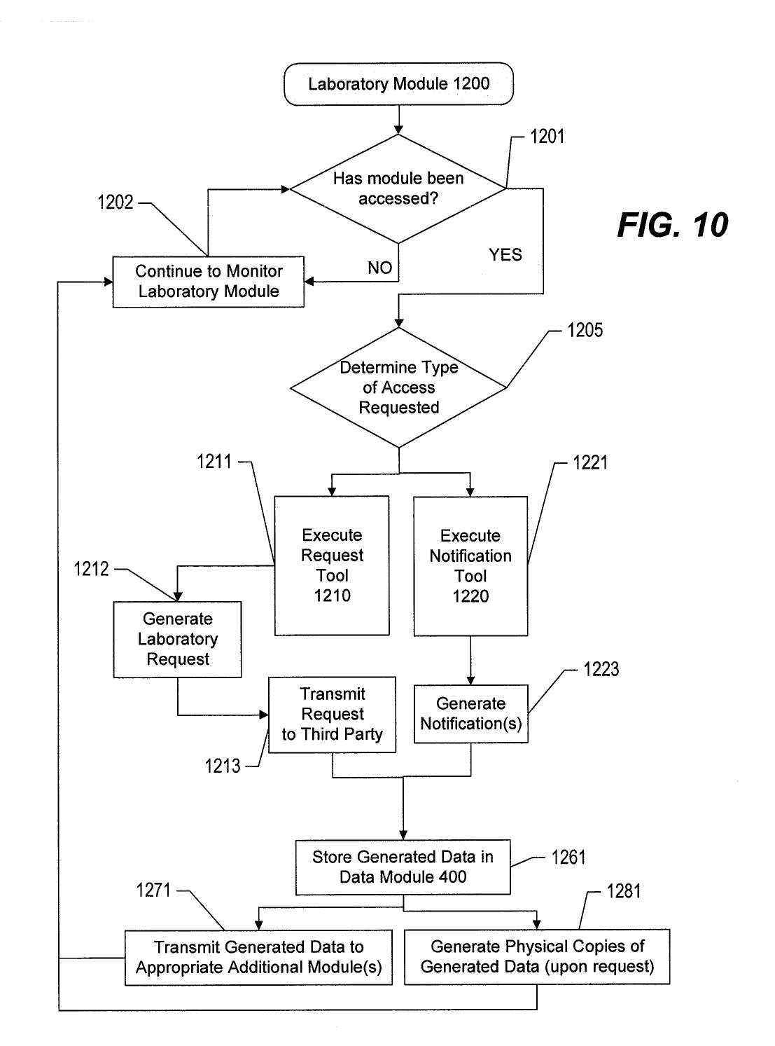

FIG. 10 illustrates steps that may be executed by the laboratory module 1200 according to various embodiments. Beginning with step 1201, the laboratory module 1200 periodically monitors whether the module has been accessed, whether via the data acquisition devices 120, the remote terminals 100, and/or any of the aforementioned remaining modules of the system 5. If, during step 1201, the laboratory module 1200 determines that it has not been accessed, the module proceeds to step 1202, in which continues to monitor itself for further access, creating an iterative loop back to step 1201. If, during step 1201, whether when initially there or returning iteratively, the laboratory module 1200 determines that access has occurred, the module proceeds to step 1205, during which the type of access being requested is determined according to various embodiments.

If, during step 1205 according to various embodiments, it was determined by the laboratory module 1200 that access was requested for purposes of submitting a laboratory test/services request, the module proceeds to execute the request tool 1210 (as previously described herein) to generate a laboratory test/services request during step 1212. The laboratory module 1200 according to various embodiments would then proceed to step 1213, during which the request is transmitted to an appropriate party (e.g., personnel at a dedicated laboratory or testing facility) for resolution and/or handling.

Once the laboratory request is transmitted during step 1213, the laboratory module 1200 according to various embodiments then proceeds to step 1261, during which any data generated during at least steps 1211, 1212, and 1213 by the request tool 1210 is transmitted to and stored within the data module 400. In certain embodiments, such will involve automatic updating of existing records with newly stored data, while in other embodiments, such may involve further transmitting a notification to at least the admin module 500 and the EMR module 700 prior to updating (and potentially overwriting) existing records. In these and still other embodiments, once the data is transmitted to and stored within the data module 400, the laboratory module 1200 may be further configured to transmit the data to additional modules (e.g., any of those illustrated in FIG. 3) and/or generate a physical copy of any generated or updated data, each however as may be desirable for a particular application.

Returning to FIG. 10, and in particular to step 1205 according to various embodiments of the laboratory module 1200, if during that step the module determines that some sort of notification data 415 (see FIG. 3) is being requested or is warranted, the module will proceed to step 1221 instead of the previously described step 1211. During step 1221 according to various embodiments, the laboratory module 1200 is configured to execute a notification tool 1220 configured to generate any of a variety of notifications (e.g., notice of insurance not covering a particular radiology request, notice of radiology request being completed, notice of unexpected delay in completion of request, etc.), all as may be desirable and beneficial for particular applications. In this regard, according to these and still other embodiments, for purposes of at least efficiency and accuracy, the laboratory module 1200, after completing step 1223, may similarly proceed to step 1261, during which any data generated during at least steps 1221 and 1223 by the notification tool 1220 is transmitted to and stored within the data module 400, whether automatically or upon subsequent review and approval, all as previously described herein.

It should be further understood that the access of the laboratory module 1200 according to various embodiments may be bi-directional, in which case, instead of the requesting doctor accessing the module (e.g., in step 1201, as previously described herein) it is instead the external third-party radiology personnel accessing the module. In certain embodiments, such access may be for purposes of notifying the laboratory module 1200 that a laboratory order has been completed. In other embodiments, such access may further involve payment for and settlement of the charges associated with the prescription, whether via the financial module 600 and/or the insurance module 2200, both of which have been described elsewhere herein in their entirety.

### 9. Referral Module Logic

According to various embodiments, the referral module 1300 is configured to execute at least one or more of a request tool 1310 and/or a notification tool 1320 in response to the referral module 1300 being accessed by one or more users of the system 5. In certain embodiments, it should be understood that the referral module 1300 provides an efficiently integrated tool for the electronic transfer of information between veterinary clinics or specialty hospitals/universities, patients treated at such facilities or the owners thereof, and third-party referral-receiving facilities (e.g., additional specialty hospitals/universities, cancer treatment facilities, etc.).

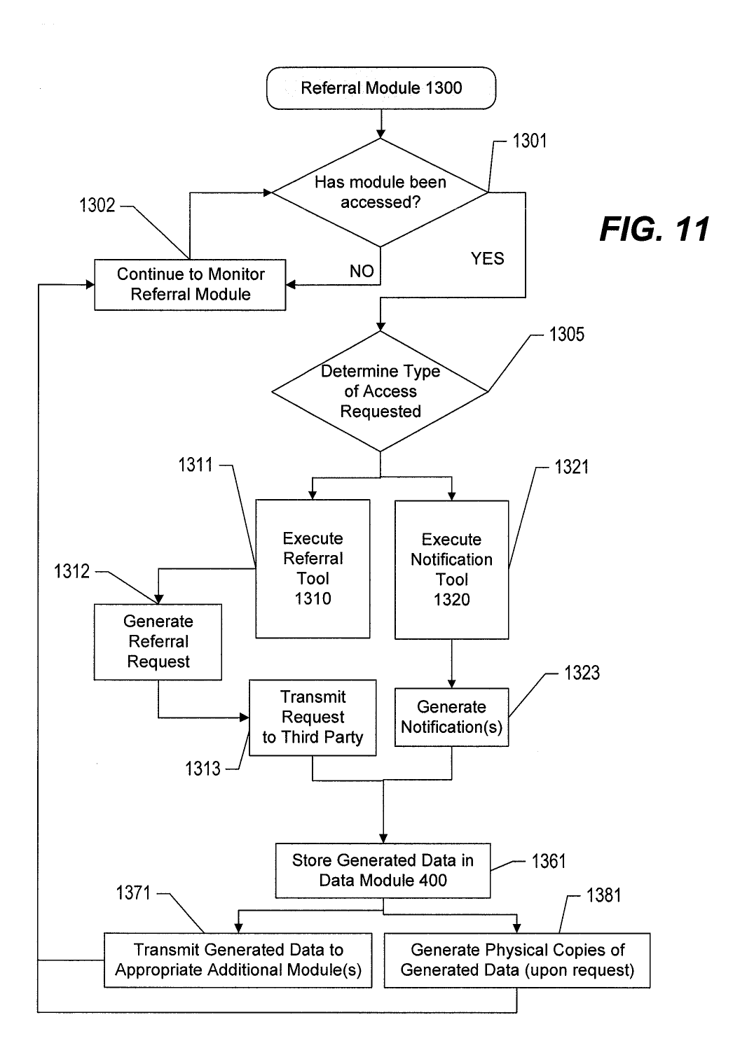

FIG. 11 illustrates steps that may be executed by the referral module 1300 according to various embodiments. Beginning with step 1301, the referral module 1300 periodically monitors whether the module has been accessed, whether via the data acquisition devices 120, the remote terminals 100, and/or any of the aforementioned remaining modules of the system 5. If, during step 1301, the referral module 1300 determines that it has not been accessed, the module proceeds to step 1302, in which continues to monitor itself for further access, creating an iterative loop back to step 1301. If, during step 1301, whether when initially there or returning iteratively, the referral module 1300 determines that access has occurred, the module proceeds to step 1305, during which the type of access being requested is determined according to various embodiments.

If, during step 1305 according to various embodiments, it was determined by the referral module 1300 that access was requested for purposes of submitting a referral, the module proceeds to execute the referral request tool 1310 (as previously described herein) to generate a referral request during step 1312. The referral module 1300 according to various embodiments would then proceed to step 1313, during which the request is transmitted to an appropriate party for resolution and/or handling.

Once the request is transmitted during step 1313, the referral module 1300 according to various embodiments then proceeds to step 1361, during which any data generated during at least steps 1311, 1312, and 1313 by the referral request tool 1310 is transmitted to and stored within the data module 400. In certain embodiments, such will involve automatic updating of existing records with newly stored data, while in other embodiments, such may involve further transmitting a notification to at least the admin module 500, the customer portal module 1500, and the EMR module 700 prior to updating (and potentially overwriting) existing records. In these and still other embodiments, once the data is transmitted to and stored within the data module 400, the referral module 1300 may be further configured to transmit the data to still further additional modules (e.g., any of those illustrated in FIG. 3) and/or generate a physical copy of any generated or updated data, each however as may be desirable for a particular application.

Returning to FIG. 11, and in particular to step 1305 according to various embodiments of the referral module 1300, if during that step the module determines that some sort of notification data 415 (see FIG. 3) is being requested or is warranted, the module will proceed to step 1321 instead of the previously described step 1311. During step 1321 according to various embodiments, the referral module 1300 is configured to execute a notification tool 1320 configured to generate any of a variety of notifications (e.g., notice of referral request to third party, notice of referral request to patient owner via customer portal module 1500, notice of completion of referral appointment and associated treatments as applicable, etc.), all as may be desirable and beneficial for particular applications. In this regard, according to these and still other embodiments, for purposes of at least efficiency and accuracy, the referral module 1300, after completing step 1323, may similarly proceed to step 1361, during which any data generated during at least steps 1321 and 1323 by the notification tool 1320 is transmitted to and stored within the data module 400, whether automatically or upon subsequent review and approval, all as previously described herein.

It should be further understood that the access of the referral module 1300 according to various embodiments may be bi-directional, in which case, instead of the requesting doctor accessing the module (e.g., in step 1201, as previously described herein) it is instead the external third-party referral receiving personnel accessing the module. In certain embodiments, such access may be for purposes of notifying the referral module 1300 that a referral treatment and/or appointment has been completed, perhaps requesting a follow-up or advisement session with the originally referring doctor, as desirable in certain embodiments. In other embodiments, such access may further involve payment for and settlement of the charges associated with the any services rendered during the referral, whether via the financial module 600 and/or the insurance module 2200, both of which have been described elsewhere herein in their entirety.

### 10. Customer Portal Module Logic

According to various embodiments, the customer portal module 1500 is configured to execute at least one or more of an admin tool 1510, a financial tool 1520, an EMR tool 1530, a prescription tool 1540, a result tool 1550, a referral tool 1560, an insurance tool 1570, and/or one or more plug-in module tools 1580 in response to the customer portal module 1500 being accessed by one or more users of the system 5. In certain embodiments, it should be understood that the customer portal module 1500 provides an efficiently integrated tool for the electronic communication of medical treatment and services data between the customer (e.g., patient/owner) and a veterinarian service provider (whether clinical or specialty context), including in at least certain embodiments further interfacing with various external third party entities such as the non-limiting examples of pharmacies, insurance providers, and/or referral offices. It should be understood, however, that the customer portal module 1500, together with the EMR module 700 provides a seamless interface between which a plurality of data may be efficiently and effectively transferred, as compared to traditional systems offered in this regard.

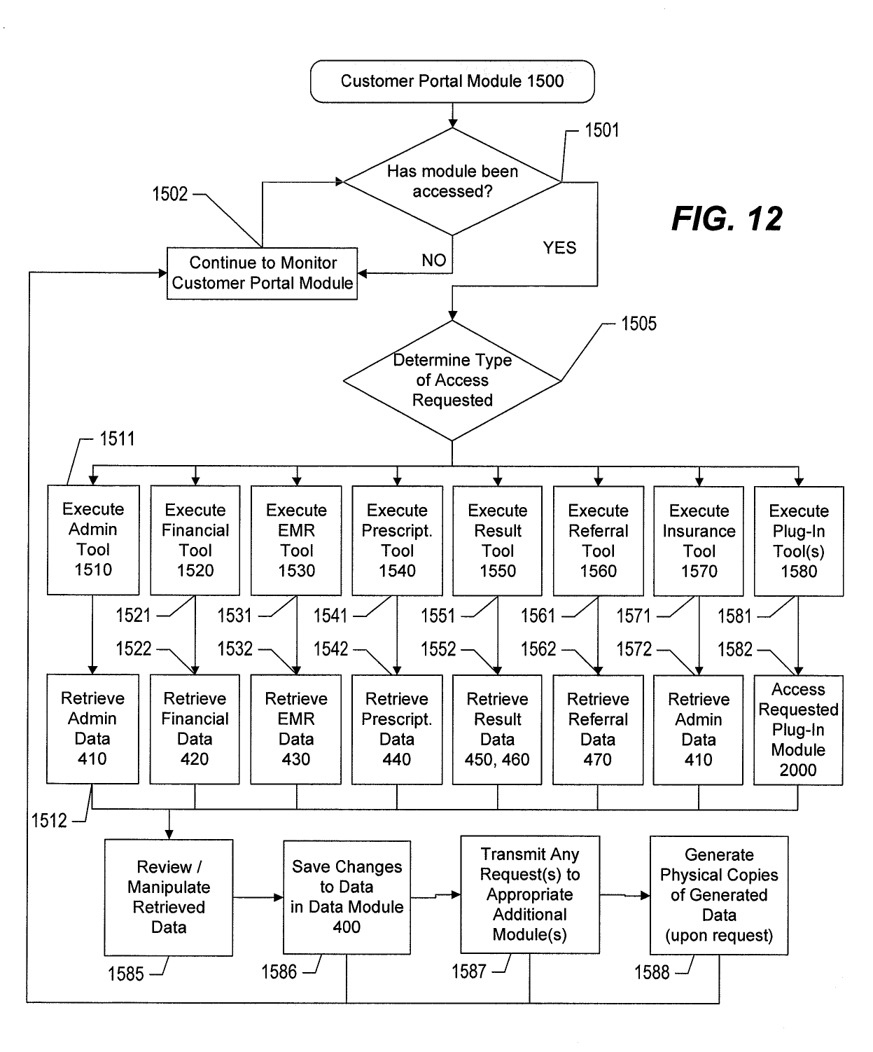

FIG. 12 illustrates steps that may be executed by the customer portal module 1500 according to various embodiments. Beginning with step 1501, the customer portal module 1500 periodically monitors whether the module has been accessed, whether via the data acquisition devices 120, the remote terminals 100, and/or any of the aforementioned remaining modules of the system 5. If, during step 1501, the customer portal module 1500 determines that it has not been accessed, the module proceeds to step 1502, in which continues to monitor itself for further access, creating an iterative loop back to step 1501. If, during step 1501, whether when initially there or returning iteratively, the customer portal module 1500 determines that access has occurred, the module proceeds to step 1505, during which the type of access being requested is determined according to various embodiments.

It should be understood that during step 505, it may be determined according to various embodiments that access is requested regarding data acquired, maintained, and/or updated by any one of the modules described elsewhere herein (e.g., the admin module 500, the financial module 600, the EMR module 700, the prescription module 1000, the radiology module 1100, the laboratory module 1200, the referral module 1300, and any one of the plurality of plug-in modules 2000. Depending upon the nature of the access requested by the customer, any of a variety of tools may be executed to retrieve the associated and corresponding data, as stored within the data module 400. As a non-limiting example, a user of the customer portal module 1500 may request information regarding their latest outstanding bill, in which case the module would in step 1521 execute a financial tool 1520 to retrieve financial data 420 (see also FIG. 3) from the data module 400. In another non-limiting example, the user may request information regarding their latest prescribed prescription, whether to seek refilling of the same, initial fulfillment, status, or otherwise, in any of which cases, the module would in step 1541 execute a prescription tool 1540 to retrieve prescription data 440 (see also FIG. 3) from within the data module 400. It should be understood of course that these are exemplary requests, as FIG. 12 further illustrates additional tools, such as, for example, an admin tool 1510, an EMR tool 1530, a result tool 1550, a referral tool 1560, an insurance tool 1570, and a plug-in tool 1580, each configured respectively to retrieve any of a variety of data likewise stored within the data module 400, as may be desirable for particular applications.

Returning to FIG. 12, it should be understood that at least one of the benefits of the customer portal module 1500 is seamless, real-time access to electronic data for the customer. According to various embodiments, once any of a variety of requested data is retrieved, the customer portal module 1500 may proceed to step 1585, during which the customer may review or otherwise manipulate (e.g., update status, pay a bill, remind an insurance provider of a claim, or otherwise) the data. Once such is completed in these and other embodiments, the customer portal module 1500 is configured in step 1586 to save any manipulations made by users. Still further, in certain embodiments, the user accessing the customer portal module 1500 may, during step 1587, forward any requests, modifications, or inquiries to additional modules, as may be appropriate for particular applications. As a non-limiting example, if the user accesses the module 1500 and makes a payment against an invoice, the module may, during step 1587 forward that payment data to the financial module 600 for processing by at least the accounting tool 640, as previously described herein. Of course, any of a variety of data may be input, modified, and manipulated, and such may be likewise transmitted to any of the corresponding modules as described elsewhere herein, as may be most pertinent and useful for particular circumstances and/or applications.

It should further be understood that the customer portal module 1500, like many of the modules described elsewhere herein, may be configured during step 1588 to further generate physical copies of any data requested or generated by the user of the module. As a non-limiting example, the user may generate a physical copy of an unfulfilled prescription (e.g., by printing such on a printer or otherwise). Alternatively, the user may wish to print a copy of laboratory results, if such were retrieved by the result tool 1550, as previously described herein. It should be understood, of course, that according to various embodiments, any of a variety of requested and/or generated data may be not only updated and stored upon the data module 400 of the system, but also physically generated by the user of the customer portal module 1500, as may be desirable under particular circumstances and/or applications.

### 11. App Mart Module Logic

According to various embodiments, the App Mart module 2100 is configured to execute at least one or more of an App upload/download tool 2110 and/or an App Launch tool 2120 in response to the App Mart module 2100 being accessed by one or more users of the system 5. In certain embodiments, it should be understood that the App Mart module 2100 provides an efficiently integrated marketplace through which a plurality user of the system 5 (and even multiple installations of the system 5 across distributed locations) may exchange and use any of a variety of independently developed applications (e.g., program modules) designed to enhance various capabilities of the system, as may be desirable for a particular application.

FIG. 6 illustrates steps that may be executed by the App Mart module 2100 according to various embodiments. Beginning with step 2101, the App Mart module 2100 periodically monitors whether the module has been accessed, whether via the data acquisition devices 120, the remote terminals 100, and/or any of the aforementioned remaining modules of the system 5. If, during step 2101, the App Mart module 2100 determines that it has not been accessed, the module proceeds to step 2102, in which continues to monitor itself for further access, creating an iterative loop back to step 2101. If, during step 2101, whether when initially there or returning iteratively, the App Mart module 2100 determines that access has occurred, the module proceeds to step 2105, during which the type of access being requested is determined according to various embodiments.

If, during step 2105 according to various embodiments, it was determined by the App Mart module 2100 that access was requested for purposes of uploading or downloading a particular mobile application, the module proceeds to execute the upload/download tool 2110 (as previously described herein) to either upload a new mobile application (e.g., one being submitted by a third-party developer or comparable party) or to download (or even update) a mobile application (e.g., one a user of the system—whether a doctor, pharmacist, or patient owner, etc.—wishes to install on a mobile device for purposes of accessing at least certain features of the system) during step 2112. Mobile applications and mobile application “stores” are commonly known and understood in the art and as such their functionality and interoperability will not be described in further detail herein, other than for purposes of describing the interaction between the App Mart module 2100 and the system 5, as described elsewhere herein.

If upload or download of a mobile application is desired, the App Mart module 2100 according to various embodiments would then proceed to step 2113, during which the exchange of the application is handled and a confirmation is transmitted to various parties. In certain embodiments, the confirmation may only be transmitted to the uploading or downloading party, while in other embodiments the confirmation may be transmitted to a variety of users of the system, as may be desirable for particular applications (e.g., for instance, to advertise the availability of a new mobile application). In any event, once the application exchange is confirmed during step 2113, the App Mart module 2100 according to various embodiments then proceeds to step 2161, during which any data generated during at least steps 2111 and 2113 by the App Mart module 2100 is transmitted to and stored within the data module 400.

In various embodiments, updating of data by the App Mart module 2100 will involve automatic updating of existing records with newly stored data, while in other embodiments, such may involve further transmitting a notification to at least the admin module 500, the customer portal module 1500, and the EMR module 700 for purposes of making such data available to users of specifically those modules. In these and still other embodiments, once the data is transmitted to and stored within the data module 400, the App Mart module 2100 may be further configured to transmit the data to still further additional modules (e.g., any of those illustrated in FIG. 3) and/or generate a physical copy of any generated or updated data, each however as may be desirable for a particular application.

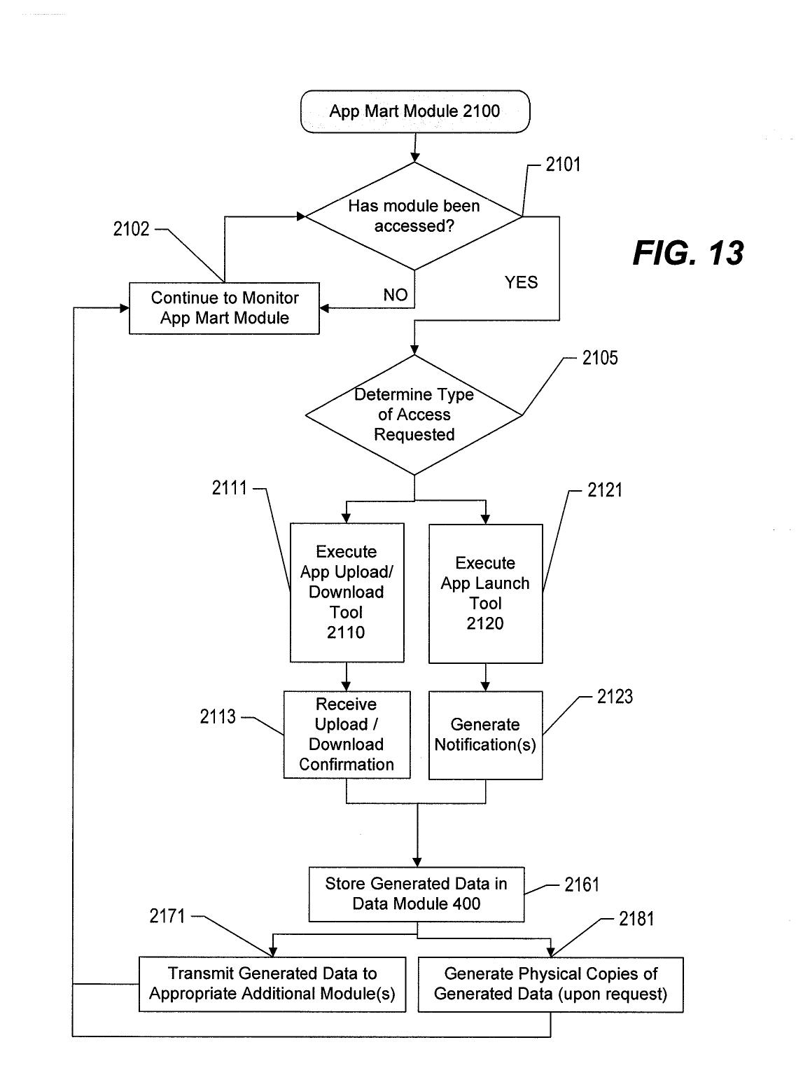

Returning to FIG. 13, and in particular to step 2105 according to various embodiments of App Mart module 2100, if during that step the module determines that some sort of notification data 415 (see FIG. 3) is being requested or is warranted, the module will proceed to step 2121 instead of (or in addition to) the previously described step 2111. During step 2121 according to various embodiments, the App Mart module 2100 is configured to execute a notification tool 2120 configured to generate any of a variety of notifications, all as may be desirable and beneficial for particular applications. In this regard, according to these and still other embodiments, for purposes of at least efficiency and accuracy, the App Mart module 2100, after completing step 2123, may similarly proceed to step 2161, during which any data generated during at least steps 2121 and 2123 by the notification tool 2120 is transmitted to and stored within the data module 400, whether automatically or upon subsequent review and approval, all as previously described herein.

It should be further understood that the access of the App Mart module 2100 according to various embodiments may be bi-directional or even multi-directional, facilitating an endless degree of sharing and development of additional features for use with the system 5. Such provides a beneficial mechanism for the spread of a wealth of information and knowledge related to veterinarian medicine, both for doctors practicing and concerned therewith and for owners of animals being treated thereby.

### 12. Insurance Module Logic

According to various embodiments, the insurance module 2200 (when present) is configured to execute at least one or more of a request tool 2210 and/or a notification tool 2220 in response to the insurance module 2200 being accessed by one or more users of the system 5. In certain embodiments, it should be understood that the insurance module 2200 provides an efficiently integrated tool for the seamless electronic transfer of information between veterinary clinics or specialty hospitals/universities, patients treated at such facilities or the owners thereof, and third-party insurance providers. In certain embodiments, the seamless electronic transfer of information may occur via the one or more networks 130 and in particular via the internet using, as a non-limiting example, extensible markup language (XML) formatting to make the data both human-readable and machine-readable with eases. Such, among other benefits, eliminates the need for patient payment of particular amounts for particular services, followed by subsequent reimbursement of the same in part or in full (or even otherwise) by the insurance provider, as the insurance claim and settlement process is resolved essentially simultaneous with the provision of services over the internet using, for example XML.

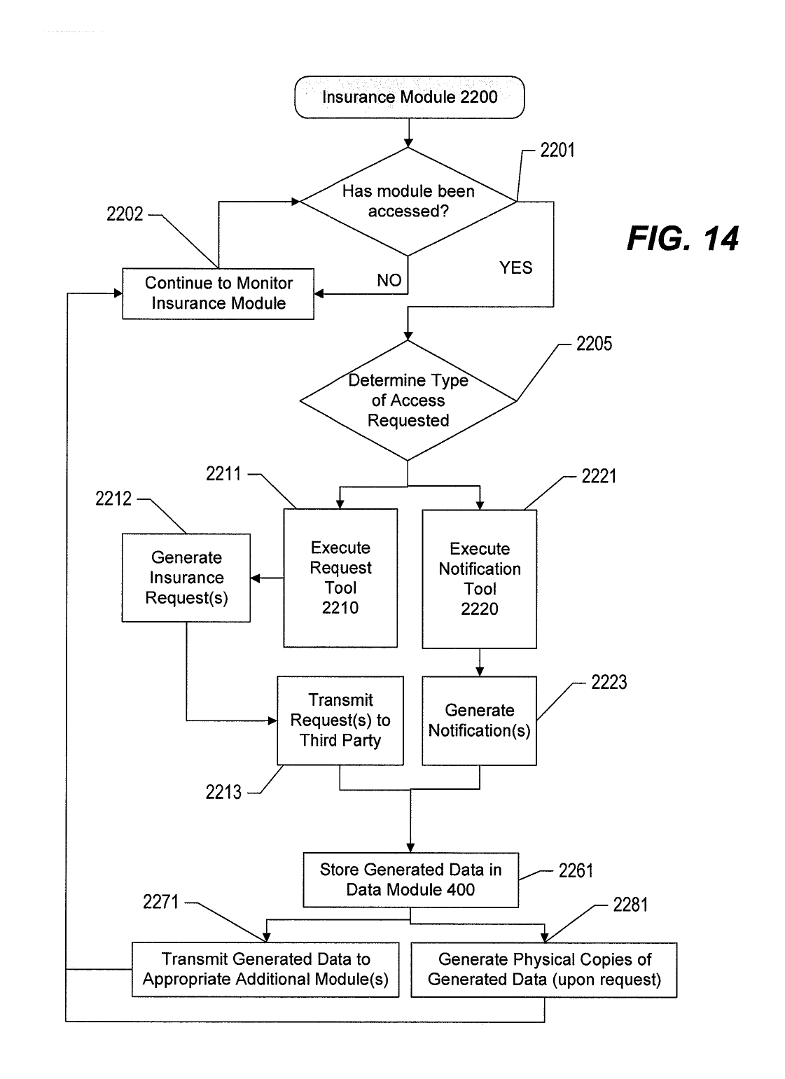

FIG. 14 illustrates steps that may be executed by the insurance module 2200 according to various embodiments. Beginning with step 2201, the insurance module 2200 periodically monitors whether the module has been accessed, whether via the data acquisition devices 120, the remote terminals 100, and/or any of the aforementioned remaining modules of the system 5. If, during step 2201, the insurance module 2200 determines that it has not been accessed, the module proceeds to step 2202, in which continues to monitor itself for further access, creating an iterative loop back to step 2201. If, during step 2201, whether when initially there or returning iteratively, the insurance module 2200 determines that access has occurred, the module proceeds to step 2205, during which the type of access being requested is determined according to various embodiments.

If, during step 2205 according to various embodiments, it was determined by the insurance module 2200 that access was requested for purposes of submitting a referral, the module proceeds to execute the request tool 2210 (as previously described herein) to generate a request during step 2212. The insurance module 2200 according to various embodiments would then proceed to step 2213, during which the request is transmitted to an appropriate party for resolution and/or handling, namely the insurance carrier with whom the patient's owner has contracted with for insurance coverage of veterinarian services.

Once the insurance request is transmitted during step 2213, the insurance module 2200 according to various embodiments then proceeds to step 2261, during which any data generated during at least steps 2211, 2212, and 2213 by the insurance module 2200 is transmitted to and stored within the data module 400. In certain embodiments, such will involve automatic updating of existing records with newly stored data, while in other embodiments, such may involve further transmitting a notification to at least the admin module 500, the customer portal module 1500, and the EMR module 700 prior to updating (and potentially overwriting) existing records. In these and still other embodiments, once the data is transmitted to and stored within the data module 400, the insurance module 2200 may be further configured to transmit the data to still further additional modules (e.g., any of those illustrated in FIG. 3) and/or generate a physical copy of any generated or updated data, each however as may be desirable for a particular application.

Returning to FIG. 14, and in particular to step 2205 according to various embodiments of the insurance module 2200, if during that step the module determines that some sort of notification data 415 (see FIG. 3) is being requested or is warranted, the module will proceed to step 2221 instead of the previously described step 2211. During step 2221 according to various embodiments, the insurance module 2200 is configured to execute a notification tool 2220 configured to generate any of a variety of notifications (e.g., notice of amount of insurance coverage, notice of delinquent or altered coverage, etc.), all as may be desirable and beneficial for particular applications. In this regard, according to these and still other embodiments, for purposes of at least efficiency and accuracy, the insurance module 2200, after completing step 2223, may similarly proceed to step 2261, during which any data generated during at least steps 2221 and 2223 by the notification tool 2220 is transmitted to and stored within the data module 400, whether automatically or upon subsequent review and approval, all as previously described herein.

It should be further understood that the access of the insurance module 2200 according to various embodiments may be bi-directional, in which case, instead of the requesting doctor accessing the module (e.g., in step 2201, as previously described herein) it is instead the external third-party insurance provider accessing the module. In certain embodiments, such access may be for purposes of notifying the insurance module 2200 that a treatment procedure has been accepted for coverage. In other embodiments, such access may further involve payment for and settlement of the charges associated with the services rendered, whether via the financial module 600 and/or the customer portal module 1500, both of which have been described elsewhere herein in their entirety.

### 13. Analytics Module Logic

According to various embodiments, the analytics module 2300 (when present) is configured to execute at least one or more of an analytics tool 2310 and/or a notification tool 2320 in response to the analytics module 2300 being accessed by one or more users of the system 5. In certain embodiments, it should be understood that the analytics module 2300 provides an efficiently integrated tool for the seamless sharing of various data (e.g., within the shared database 402 of the data module 400) with various subscribed users of the system 5. In certain embodiments, access to the analytics-based tools of the analytics module 2300 is provided on a subscription-based service, while in other embodiments, access is on a tier-data basis, with fees associated therewith related in some manner to the value of the requested analytics and/or data. It should be understood, however, that regardless of the manner in which implemented, the analytics module 2300 provides a significant benefit over previously provided systems in that it facilitates seamless exchange and analysis of a variety of data related to the administrative and substantive management of a medical practice in, for example, the veterinarian context.

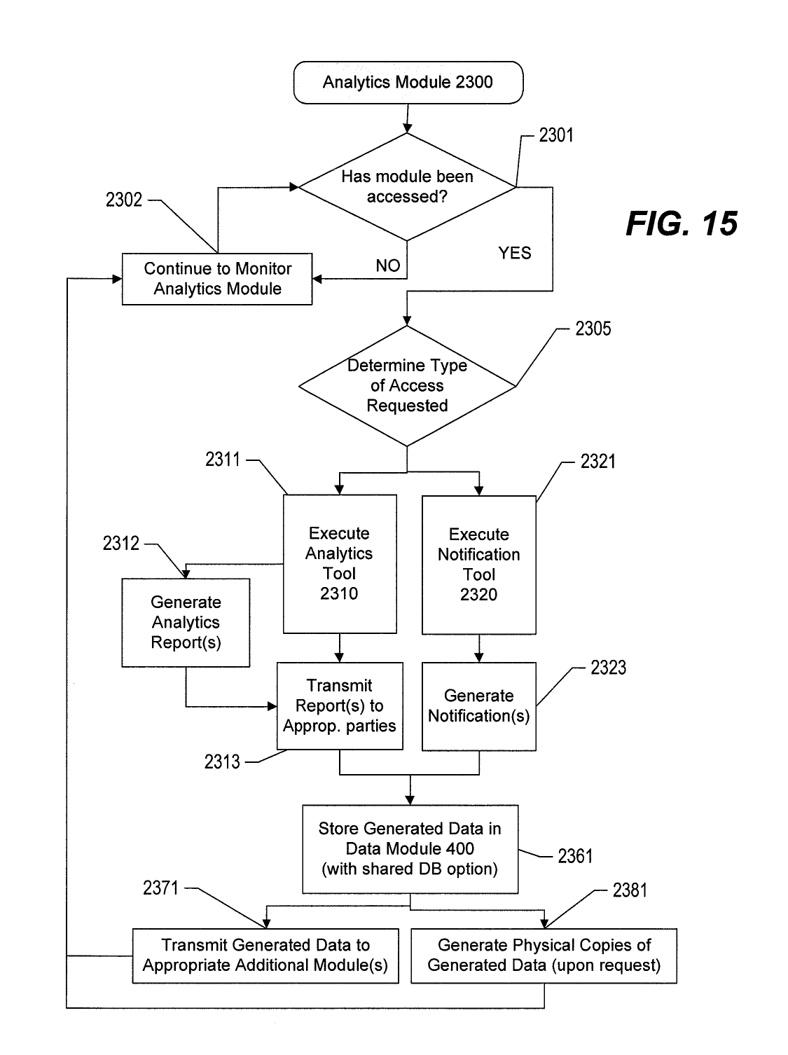

FIG. 15 illustrates steps that may be executed by the analytics module 2300 according to various embodiments. Beginning with step 2301, the analytics module 2300 periodically monitors whether the module has been accessed, whether via the data acquisition devices 120, the remote terminals 100, and/or any of the aforementioned remaining modules of the system 5. If, during step 2301, the analytics module 2300 determines that it has not been accessed, the module proceeds to step 2302, in which continues to monitor itself for further access, creating an iterative loop back to step 2301. If, during step 2301, whether when initially there or returning iteratively, the analytics module 2300 determines that access has occurred, the module proceeds to step 2305, during which the type of access being requested is determined according to various embodiments.

If, during step 2305 according to various embodiments, it was determined by the analytics module 2300 that access was requested for purposes of requesting an analytics report, the module proceeds to execute the analytics tool 2310 (as previously described herein) to generate an analytics report during step 2312. The analytics module 2300 according to various embodiments would then proceed to step 2313, during which the report is transmitted to the requesting party for viewing and perhaps further analysis and/or sharing.

Once the analytics report is transmitted during step 2313, the analytics module 2300 according to various embodiments then proceeds to step 2361, during which any data and/or reports generated during at least steps 2311, 2312, and 2313 by the analytics module 2300 is transmitted to and stored within the data module 400. In certain embodiments, such will involve automatic updating of existing records with newly stored data, while in other embodiments, such may involve further transmitting a notification to at least the admin module 500 and the community module 2400 prior to updating (and potentially overwriting) existing records. In these and still other embodiments, once the data is transmitted to and stored within the data module 400, the analytics module 2300 may be further configured to transmit the data to still further additional modules (e.g., any of those illustrated in FIG. 3 to which such data may be transmitted for privacy and/or information security reasons) and/or generate a physical copy of any generated or updated data, each however as may be desirable for a particular application.

Returning to FIG. 15, and in particular to step 2305 according to various embodiments of the analytics module 2300, if during that step the module determines that some sort of notification data 415 (see FIG. 3) is being requested or is warranted, the module will proceed to step 2321 instead of the previously described step 2311. During step 2321 according to various embodiments, the analytics module 2300 is configured to execute a notification tool 2320 configured to generate any of a variety of notifications, all as may be desirable and beneficial for particular applications. In this regard, according to these and still other embodiments, for purposes of at least efficiency and accuracy, the analytics module 2300, after completing step 2323, may similarly proceed to step 2361, during which any data generated during at least steps 2321 and 2323 by the notification tool 2320 is transmitted to and stored within the data module 400, whether automatically or upon subsequent review and approval, all as previously described herein.

It should be further understood that the access of the analytics module 2300 according to various embodiments may be bi-directional, in which case, instead of a doctor of a particular system 5 accessing the module to analyze data within his/her own system (e.g., in step 2301, as previously described herein) it is instead an external third-party user of a distributed system 5 accessing the module to analyze data within the first mentioned doctor's system 5. In still other embodiments, the access and distribution of analytics data may be multi-directional, dependent of course upon access limitations to such data based upon for example the subscription based fees described previously herein.

### 14. Community Module Logic

According to various embodiments, the community module 2400 (when present) is configured to execute at least one or more of an forum (e.g., data sharing) tool 2410 and/or a notification tool 2420 in response to the community module 2400 being accessed by one or more users of the system 5. In certain embodiments, it should be understood that the community module 2400 provides an efficiently integrated tool for the seamless sharing of various data (e.g., within the shared database 402 of the data module 400) beyond that even previously described with regard to the analytics module 2300. Indeed, in contrast with the shared analytics data, the community module 2400 provides a mechanism through which any of a variety of involved individuals may contribute their own additional data to the system 5 (e.g., a patient's owner sharing their success with medication “Y,” or a doctor sharing his observations with treating patient Z with medication “O”, etc.). It should be understood, however, that like the analytics module 2300, access to the data shared by and created via the community module 2400 could, in at least certain embodiments be subject to restriction based upon any of a variety of subscription-based fee requirements, beyond the mere license and registration for use of the system 5.

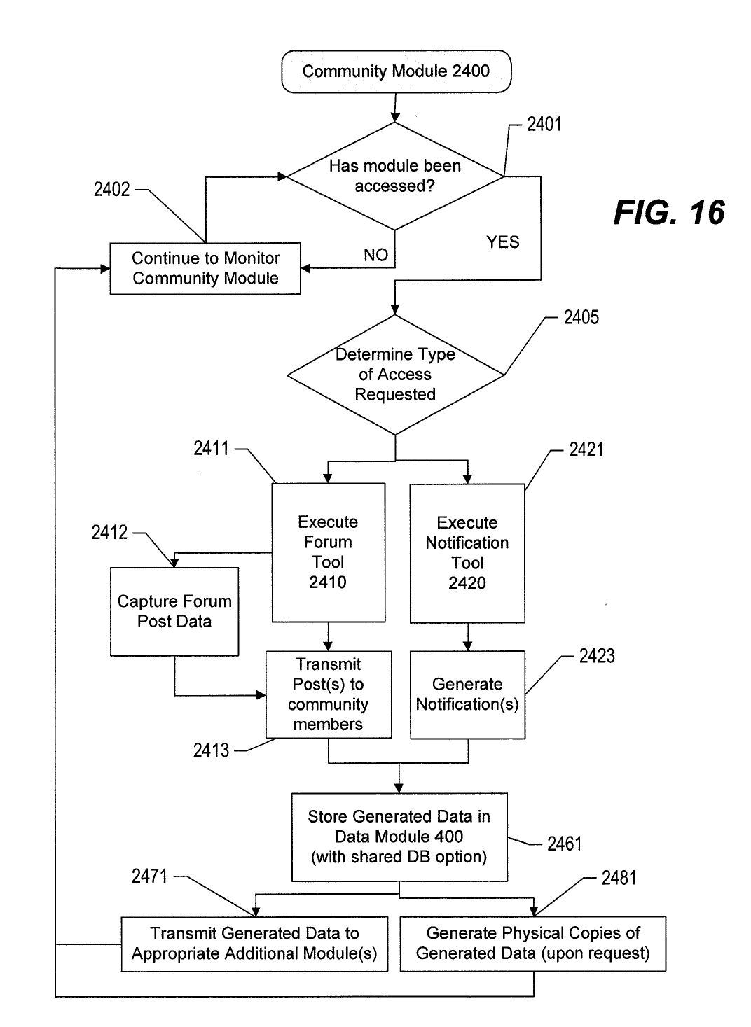

FIG. 16 illustrates steps that may be executed by the community module 2400 according to various embodiments. Beginning with step 2401, the community module 2400 periodically monitors whether the module has been accessed, whether via the data acquisition devices 120, the remote terminals 100, and/or any of the aforementioned remaining modules of the system 5. If, during step 2401, the community module 2400 determines that it has not been accessed, the module proceeds to step 2402, in which continues to monitor itself for further access, creating an iterative loop back to step 2401. If, during step 2401, whether when initially there or returning iteratively, the community module 2400 determines that access has occurred, the module proceeds to step 2405, during which the type of access being requested is determined according to various embodiments.

If, during step 2405 according to various embodiments, it was determined by the community module 2400 that access was requested for purposes of accessing (e.g., viewing and posting upon existing data, posting new data, etc.) a forum, the module proceeds to execute the forum tool 2410 (as previously described herein) to capture forum post data during step 2412. The community module 2400 according to various embodiments would then proceed to step 2413, during which the newly posted data is transmitted to other users having access to the community module 2400 for their viewing and perhaps further analysis and/or sharing.

Once the newly posted data is transmitted during step 2413, the community module 2400 according to various embodiments then proceeds to step 2461, during which any data and/or posts generated during at least steps 2411, 2412, and 2413 by the community module 2400 is transmitted to and stored within the data module 400. In certain embodiments, such will involve automatic updating of existing records with newly stored data, while in other embodiments, such may involve further transmitting a notification to at least the admin module 500 prior to updating (and potentially overwriting) existing records. In these and still other embodiments, once the data is transmitted to and stored within the data module 400 (e.g., post to forum associated with a particular patient owner's record), the community module 2400 may be further configured to transmit the data to still further additional modules (e.g., any of those illustrated in FIG. 3 to which such data may be transmitted for privacy and/or information security reasons) and/or generate a physical copy of any generated or updated data, each however as may be desirable for a particular application.

Returning to FIG. 16, and in particular to step 2405 according to various embodiments of the community module 2400, if during that step the module determines that some sort of notification data 415 (see FIG. 3) is being requested or is warranted, the module will proceed to step 2421 instead of the previously described step 2411. During step 2421 according to various embodiments, the community module 2400 is configured to execute a notification tool 2420 configured to generate any of a variety of notifications, all as may be desirable and beneficial for particular applications. In this regard, according to these and still other embodiments, for purposes of at least efficiency and accuracy, the community module 2400, after completing step 2423, may similarly proceed to step 2461, during which any data generated during at least steps 2421 and 2423 by the notification tool 2420 is transmitted to and stored within the data module 400, whether automatically or upon subsequent review and approval, all as previously described herein.

It should be further understood that the access of the community module 2400 according to various embodiments may be bi-directional or multi-direction, through which any of a variety of users of any of a variety of distributed system(s) 5 may access the community module and post, share, and otherwise distribute and/or comment upon data contained therein. Such provides a beneficial mechanism for the spread of a wealth of information and knowledge related to veterinarian medicine, both for doctors practicing and concerned therewith and for owners of animals being treated thereby.

### 15. Reference Module Logic

According to various embodiments, the reference module 2500 (when present) is configured to execute at least one or more of a search tool 2510 and/or a notification tool 2520 in response to the reference module 2500 being accessed by one or more users of the system 5. In certain embodiments, it should be understood that the reference module 2500 provides an efficiently integrated tool with which doctors and patient owners alike may educate themselves and/or others regarding various treatments, possible drug interactions, and a myriad of other possible concerns. Such, among other benefits, provides an easily accessible resource through which all those parties involved in veterinarian medicine and treatment may be educated so as to make informed decisions, as appropriate.

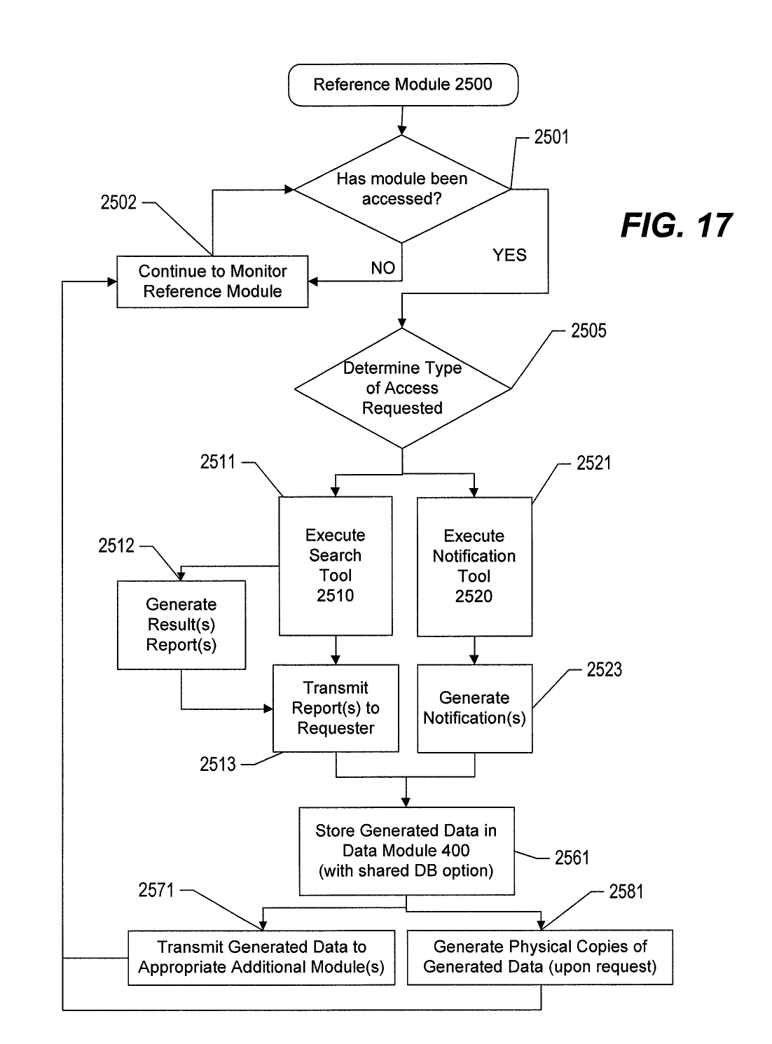

FIG. 17 illustrates steps that may be executed by the reference module 2500 according to various embodiments. Beginning with step 2501, the reference module 2500 periodically monitors whether the admin module has been accessed, whether via the data acquisition devices 120, the remote terminals 100, and/or any of the aforementioned remaining modules of the system 5. If, during step 2501, the reference module 2500 determines that it has not been accessed, the module proceeds to step 2502, in which continues to monitor itself for further access, creating an iterative loop back to step 2501. If, during step 2501, whether when initially there or returning iteratively, the reference module 2500 determines that access has occurred, the module proceeds to step 2505, during which the type of access being requested is determined according to various embodiments.

If, during step 2505 according to various embodiments, it was determined by the reference module 2500 that access was requested for purposes of performing a search, the module proceeds to execute the search tool 2510 (as previously described herein) to run the search and generate a search result report during step 2512. The reference module 2500 according to various embodiments would then proceed to step 2513, during which the request is transmitted to an appropriate party for resolution and/or handling, namely the insurance carrier with whom the patient's owner has contracted with for insurance coverage of veterinarian services.

Once the request/report is transmitted during step 2513, the reference module 2500 according to various embodiments then proceeds to step 2561, during which any data generated during at least steps 2511, 2512, and 2513 by the reference module 2500 is transmitted to and stored within the data module 400. In certain embodiments, such will involve automatic updating of existing records with newly stored data, while in other embodiments, such may involve further transmitting a notification to at least the admin module 500, the customer portal module 1500, and the EMR module 700 prior to updating (and potentially overwriting) existing records. In these and still other embodiments, once the data is transmitted to and stored within the data module 400, the reference module 2500 may be further configured to transmit the data to still further additional modules (e.g., any of those illustrated in FIG. 3) and/or generate a physical copy of any generated or updated data, each however as may be desirable for a particular application.

Returning to FIG. 17, and in particular to step 2505 according to various embodiments of the reference module 2500, if during that step the module determines that some sort of notification data 415 (see FIG. 3) is being requested or is warranted, the module will proceed to step 2521 instead of the previously described step 2511. During step 2521 according to various embodiments, the reference module 2500 is configured to execute a notification tool 2520 configured to generate any of a variety of notifications (e.g., notice of amount of insurance coverage, notice of delinquent or altered coverage, notice of, etc.), all as may be desirable and beneficial for particular applications. In this regard, according to these and still other embodiments, for purposes of at least efficiency and accuracy, the reference module 2500, after completing step 2523, may similarly proceed to step 2561, during which any data generated during at least steps 2521 and 2523 by the notification tool 2520 is transmitted to and stored within the data module 400, whether automatically or upon subsequent review and approval, all as previously described herein.

It should be further understood that the access of the reference module 2500 according to various embodiments may be bi-directional, in which case, instead of the requesting doctor accessing the module (e.g., in step 2501, as previously described herein) it is instead a third-party such as, for example, the patient's owner or laboratory personnel or pharmacy technicians accessing the module. In certain embodiments, such access may be for any of a variety of purposes related to educating further the requesting party regarding a particular aspect of items related to veterinarian practice or medicinal treatment.

### V. CONCLUSION

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. For example, although customizable and specialty templates may have been described herein with regard to particular modules, it should be understood that such templates may be configured for use with any of the modules described herein. Although specific terms are employed herein, they are used in a generic and descriptive sense only and not for purposes of limitation.

That which is claimed:

1. A veterinary care management system comprising:
one or more memory storage areas; and
one or more computer processors that are configured to receive data stored in the one or more memory storage areas, wherein the one or more computer processors are configured for:
(A) receiving data associated with at least one patient of a user of the system;
(B) using at least a portion of the data to facilitate providing medical services for the at least one patient at a first location;
(C) updating at least a portion of the data based at least in part upon the facilitated medical services at the first location; and
(D) transmitting at least the updated portion of the data via a network to facilitate providing further medical services for the at least one patient at a second location.

2. The veterinary care management of claim 1, wherein:
the data received in (A) comprises financial data and insurance data; and
the one or more computer processors are further configured for:
(E) generating an invoice based at least in part upon the financial data;
(F) transmitting, via a network, to an insurance provider associated with the insurance data so as to facilitate settlement of the invoice by the insurance provider;
(G) receiving, via the network, a coverage amount available from the insurance provider;
(H) updating the invoice to deduct the coverage amount from an amount due from the at least one patient; and
(I) providing the updated invoice to the at least one patient.

3. The veterinary care management system of claim 2, wherein step (I) comprises transmitting the updated invoice electronically, via the network, to the at least one patient.

4. The veterinary care management system of claim 3, further comprising receiving, via the network, a payment authorization from the at least one patient.

5. The veterinary care management system of claim 1, wherein:
the data received in (A) comprises electronic medical record data; and
the one or more computer processors are further configured for:
(E) analyzing the electronic medical record data to determine a medical history for the at least one patient;
(F) using the medical history in (B) to update in (C) at least a portion of the data to facilitate generating a prescription for medication for the at least one patient; and
(G) transmitting, via the network, the prescription, to facilitate the further medical services in (D).

6. The veterinary care management system of claim 5, wherein the computer processors are further configured for:
in (G), automatically transmitting the prescription, via the network, to a pharmacy; and
(H) receiving, via the network, a notification that the prescription has been fulfilled.

7. The veterinary care management system of claim 6, wherein the data further comprises financial data and the computer processors are further configured for receiving, via the network, a notification that a payment has been authorized for the prescription fulfillment.

8. The veterinary care management system of claim 1, wherein:
the updated portion of the data in (D) comprises specialty data; and
the one or more computer processors are further configured for:
(E) transmitting, via the network, the specialty data to a testing facility at the second location;
(F) receiving, via the network, a notification that any tests associated with the specialty testing data have been completed; and
(G) further updating the updated portion of the data to facilitate providing further medical services for the at least one patient.

9. The veterinary care management system of claim 1, wherein the computer processors are further configured for sharing, via the network, at least the updated portion of the data, with various geographically distributed users of the system.

10. The veterinary care management system of claim 9, wherein the users of the system comprise at least at least one or more of veterinarian physicians, specialty hospital care physicians, university medical personnel, and patients of any of the same.

11. The veterinary care management system of claim 9, wherein the computer processors are further configured for:
(E) analyzing any portion of the data shared, via the network; and
(F) generating one or more reports detailing statistical data related to the portion of the shared data analyzed in (E).

12. A computer-implemented method for managing a veterinarian care practice, said method comprising the steps of:
(A) receiving data stored in a memory, said data comprising data associated with at least one patient;
(B) determining, via at least one computer processor, the usefulness of at least a portion of the data for facilitating providing initial medical services for the at least one patient;
(C) updating, via the at least one computer processor, at least a portion of the useful portion of data based at least in part upon the facilitated medical services; and
(D) transmitting, via the at least one computer processor and an associated network, at least the updated portion of the data, the updated portion being used to facilitate providing further medical services for the at least one patient at a second location.

13. The computer-implemented method of claim 12, wherein:
the data received in (A) comprises financial data and insurance data; and
the method further comprises the steps of:
(E) generating, via the at least one computer processor an invoice based at least in part upon the financial data;
(F) transmitting, via the at least one computer processor and the associated network, to an insurance provider to facilitate settlement of the invoice by the insurance provider;
(G) receiving, via the at least one computer processor and the associated network, a coverage amount available from the insurance provider;
(H) updating the invoice to deduct the coverage amount from an amount due from the at least one patient; and
(I) providing the updated invoice to the at least one patient.

14. The computer-implemented method of claim 12, wherein:
the data received in (A) comprises electronic medical record data; and
the method further comprises the steps of:
(E) analyzing, via the at least one computer processor, the electronic medical record data to determine a medical history for the at least one patient;
(F) using the medical history in (B) to update in (C) at least a portion of the data to facilitate generating a prescription for medication for the at least one patient;
(G) automatically transmitting the prescription, via the at least one computer processor and the associated network, to a pharmacy; and
(H) receiving, via the network, a notification that the prescription has been fulfilled.

15. The computer-implemented method of claim 12, wherein:
the data received in (A) comprises specialty data; and
the method further comprises the steps of:
(E) transmitting, via the at least one computer processor and the associated network, the specialty data to a testing facility at the second location;
(F) receiving, via the network, a notification that any tests associated with the specialty testing data have been completed; and
(G) further updating, via the at least one computer processor, the updated portion of the data to facilitate providing further medical services for the at least one patient.

16. A non-transitory computer program product comprising at least one computer-readable storage medium having computer-readable program code portions embodied therein, the computer-readable program code portions comprising:
a first executable portion configured for receiving data associated with at least one patient of a user of the system, said data comprising financial data and medical record data;
a second executable portion configured for using at least a portion of the data to facilitate providing medical services for the at least one patient at a first location;
a third executable portion configured for updating at least a portion of the data based at least in part upon the facilitated medical services at the first location; and
a fourth executable portion configured for transmitting at least the updated portion of the data via a network to facilitate providing further medical services for the at least one patient at a second location.
